(19) United States
(12) Patent Application Publication
(10) Pub. No.: US 2011/0289042 A1
(43) Pub. Date: Nov. 24, 2011

(54) Integrative Framework for Three-Stage Integrative Pathway Search

(75) Inventors: Christina Chan, Okemos, MI (US); Zheng Li, Haslett, MI (US)

(73) Assignee: BOARD OF TRUSTEES OF MICHAGN STATE UNIVERSITY, EAST LANSING, MI (US)

(21) Appl. No.: 11/922,803

(22) PCT Filed: Jun. 29, 2006
(86) PCT No.: PCT/US2006/025556

§ 371 Date: Jan. 9, 2009

Related U.S. Application Data
(60) Provisional application No. 60/694,956, filed on Jun. 29, 2005.

(51) Int. Cl. G06N 7/02; G06N 5/00

(52) U.S. Cl. 706/52

(57) ABSTRACT

Processes for constructing improved networks, such as Bayesian networks, of putative biomolecular pathways, that can e used to identify candidate biomolecular targets for validation as drug development targets, and the like; networks prepared thereby, use of the networks to predict the effect of biomolecule perturbations on cell phenotypes, and microprocessors and data processing systems programmed to automate the processes and software having instructions for performing the processes.

### CROSS-REFERENCE TO RELATED APPLICATIONS

This application claims the benefit of U.S. Provisional Patent Application No. 60/694,956, filed Jun. 29, 2005. The disclosure of the above application is incorporated herein by reference.

### STATEMENT OF GOVERNMENT INTEREST

This invention was funded in part by the U.S. National Science Foundation, Division of Bioengineering and Environmental Systems, grant nos. BES-0222747, BES-0331297 and BES-0425821, and the U.S. Environmental Protection Agency. The U.S. Government has certain rights to this invention.

### BACKGROUND

The statements in this section merely provide background information related to the present disclosure and may not constitute prior art.

In the post-genomic era, one fundamental task facing researchers is to understand the biological function of countless genes and how these genes and gene products interact and regulate each other to yield a functional cell with particular phenotypes. Such an understanding requires integrating features, such as signal transduction and gene regulatory, and biocatalytic (metabolic) pathways, and the like, which underlie the induction of observed phenotypes. Many phenotypes can be exhibited by a single cell, in light of the innate capacity of cells to respond to a wide variety of environmental stimuli. Studying such stimulus-induced phenotypes is important for understanding genomic and cellular functions, since many genes and their expression products are unused during normal metabolism of healthy cells on a preferred carbon source, but can remain dormant until an appropriate stimulus is encountered, e.g., an exotic carbon source, a toxin, an infective agent, a shift in temperature, or other perturbation.

In order to elucidate such a holistic understanding, accurate models must be developed that account for observations of gene and expression product activity, metabolic shifts, and other empirical data. Such data is obtained from analyses of the cellular genome (e.g., transcriptome), metabolome, and/or proteome. Extracting meaningful regulatory and biochemical pathway information from, e.g., genomic and metabolomic data, is a difficult endeavor. A number of different approaches have been attempted. However, improvements in this field are still desirable.

### SUMMARY

The present invention provides: methods for constructing putative networks that offer a significantly improved degree of predictive accuracy, i.e. an improved likelihood that a given gene, protein, function, or other node in the reconstructed network is actually involved in production of the phenotype studied in an embodiment hereof. Thus, a researcher seeking to limit the number of unproductive experiments performed in the process of identifying, e.g., the molecular elements underlying causation of a particular disease or the genes or proteins that could be used as drug targets in a process of pharmaceutical development, would be able to do so more efficiently using a network prepared according to an embodiment hereof. The present invention further provides:

Processes for constructing a network of putative biological pathway(s) involved in production of a phenotype, by providing the identity of a phenotype of interest exhibited by a selected cellular entity; and at least four sets of data: (a) each set being obtained from a sample or group of samples of the cellular entity; (1) at least one of the data sets being a first data set obtained from a sample or sample group that exhibits a first level of the phenotype; and (2) at least one of the other data sets being a second data set obtained from a sample or sample group that exhibits a second level of the phenotype, different from the first level; and (3) the remainder of the at least four data sets, if any, being independently selected from among those obtained from a sample or sample group that either does not exhibit the phenotype or that exhibits a level of the phenotype the same as or different from either of those that provides the first and second data sets; and (b) each data set including (1) biomolecule expression data for a biomolecule class, at least two of the data sets' expression data each comprising a static biomolecule expression profile for the biomolecule class, and at least a first and a second of the static biomolecule expression profiles among the data sets respectively being static biomolecule profiles from the cellular entity exhibiting different levels of the phenotype; and (2) phenotype expression data that is a measure of, or proportional to, the phenotype expression level of the sample or sample group providing that data set; using this data by

Performing a comparative analysis of the biomolecule expression profiles using Analysis of Variance (ANOVA) or an equivalent technique, or using a Partial Least Squares (PLS) Analysis, or both, to identify biomolecules whose expression level is significantly different in the cellular entity when exhibiting the phenotype to a greater degree, thereby identifying a set of altered-expression (AE) biomolecules;

Performing an analysis of the AE biomolecules using a Genetic Algorithm-coupled Partial Least Squares technique (GA/PLS), or an equivalent technique, to assign relevance values to the AE biomolecules, proportional to their degree of correlation with the phenotype, and selecting the highest-relevance-valued AE biomolecules as the set of high-relevance AE (HAE) biomolecules, wherein the GA/PLS or equivalent technique is operated on at least the four data sets defined in step (A)(2), each of the data sets comprising biomolecular expression data for each of the AE biomolecules;

Analyzing the GA/PLS-assigned relevance value of each of the HAE biomolecules, along with the biomolecule expression data for the HAE biomolecules and the phenotype expression data therefor, using Constrained Independent Component Analysis (CICA) to identify a subset of HAE biomolecules that are involved in a phenotype-expression-pathway(s), which biomolecules are thereby classified as a set of regulatory-function (RF) biomolecules; and

Analyzing the differences in expression for each of the RF biomolecules, as recorded in the biomolecule expression data, using Bayesian Network analysis to construct a network of RF biomolecules involved in producing the phenotype, each RF biomolecule being represented by a node and each node being connected to at least one other node by a connection representing the probability that those two biomolecules are functionally adjacent one another in a biological pathway in cyto, thereby obtaining said network of putative biological pathway(s);

Such processes in which the biomolecule class is any one of mRNAs, polypeptides, or metabolites, or a substantial subset thereof, and the resulting network contains putative gene, polypeptide, or metabolite pool pathway(s), respectively;

Such processes further involving using biomolecule function annotation data to eliminate from further analysis those biomolecules whose putative functions identify them as having little or no relevance to phenotype expression;

Such processes further involving using the network to predict the phenotypic effect of manipulating a biomolecule of the cellular entity or of contacting the cellular entity with an exogenous compound or condition, or using the network to identify a node as a candidate target biomolecule by predicting the effect on the phenotype of perturbing the node in the network; Such processes further involving storing the network in a computer readable memory; Such processes further involving experimentally manipulating the cellular entity by inhibiting, inactivating, or enhancing the amount or activity of a candidate target network biomolecule, such as a candidate target biomolecule, represented in the network and using the experimental results thereof to revise the network to obtain a verified network, or to validate a candidate target molecule as a target biomolecule, or both; Such processes further involving inhibiting, inactivating, or enhancing the identified gene target in the cellular entity so as to alter the phenotype;

A microprocessor programmed to perform such a process, based on data provided to the microprocessor for use therein; Data processing systems having an input device, a processor, and an output device, the processor comprising a central processing unit and memory, wherein the processor is programmed to perform such a process, and is programmed to receive data for use therein from the input device, and is programmed to transmit, to the output device, results of performing said method using said data.

Processes for selecting a candidate target biomolecule for experimental verification as a target biomolecule, the process comprising performing such a process to construct a network and then identifying a node as representing a candidate target biomolecule by predicting the effect on the phenotype of perturbing the node in the network; Such processes in which the verified target molecule is for use in drug development, molecular medicine, or phenotype modification;

Bayesian networks containing a plural number of nodes representing biomolecules, a plurality of edges connecting said nodes, the edges representing the probability that the biomolecules are functionally adjacent one another in a biological pathway in cyto, wherein said nodes and edges are operably connected by evaluating the relationships by use of such processes; and such Bayesian networks stored in a computer readable memory. Software with instructions for receiving input data and performing such a network construction process using that data.

Further areas of applicability will become apparent from the description provided herein. It should be understood that the description and specific examples are intended for purposes of illustration only and are not intended to limit the scope of the present disclosure.

### BRIEF DESCRIPTION OF DRAWINGS

The drawings described herein are for illustration purposes only and are not intended to limit the scope of the present disclosure in any way.

FIG. 1 illustrates a representative sub-network related to cytotoxicity. The relevant genes were selected with genetic algorithm-coupled/partial least squares (GA/PLS) and independent component analysis (ICA), the network was reconstructed with Bayesian network (BN) analysis. The network provided an overview of the factors and pathways that regulate the cytotoxicity.

FIG. 2 presents Western blots (A and B) and bar chart analyses (C and D) thereof, showing the effects of TNF-α and palmitate on stearoyl-CoA desaturase (SCD), which confirm the important role of SCD in palmitate-induced cytotoxicity. (A) SCD was downregulated in palmitate (0.7 mM) culture compared to oleate (0.7 mM) culture and control. (B) Co-supplementation of oleate (0.3 mM) with palmitate (0.4 mM) prevented the downregulation of SCD. (C) Co-supplementation of palmitate with oleate also correspondingly decreased LDH release. (D) TNF-α decreased the expression of SCD in control, oleate and co-supplementation cultures. Yet, gene expression of SCD was upregulated by TNF-α in HepG2 cells (FIG. 2D, measuring SCD expression in units of log 2(treatment/control)).

FIG. 3 presents a Western blot showing the effects of the antioxidant, N-acetyl-serine, on SCD measured by western blotting. Down-regulation of SCD in palmitate culture was prevented by co-supplementation of an antioxidant N-acetyl cysteine (10 mM).

FIG. 4 presents a bar chart analysis of the effects of the SCD activators, clofibrate and ciprofibrate, on LDH release in palmitate cultures. Clofibrate and ciprofibrate are known to increase the activity of SCD. 6 hours pretreatment followed by 48 hours co-supplementation of 50 μM of clofibrate and ciprofibrate significantly decrease LDH release in palmitate culture.

FIG. 5 presents Western blots showing the effects of TNF-α on PKC-δ expression measured by western blotting. Expression of PKC-δ 41 kDa catalytically active fragment was increased by TNF-α at 20 and 100 ng/mL in control, palmitate, and oleate cultures.

FIG. 6 presents Western blots (A) and a bar chart analysis (B) showing the effects of rottlerin on NF-κB. (A) Expression of phospho-P65 NF-κB in culture mediums with 0, 20, or 100 ng/mL TNF-α with and without rottlerin (5 μM). TNF-α activated phospho-P65 NF-κB and this activation was attenuated by the PKC-δ inhibitor, rottlerin. (B) Measurement of LDH release in different culture mediums with and without rottlerin. Palmitate increased LDH release compared to oleate and control cultures. Co-supplementation of oleate with palmitate reduced LDH release. Rottlerin significantly increased LDH release in palmitate culture.

FIG. 7 presents Western blots showing the effects on Bcl-2 expression of palmitate and TNF-α (A) and of PKR inhibitor (B). (A) Bcl-2 was down-regulated by TNF-α supplementation at 20-100 ng/mL concentration in control, palmitate, and oleate cultures. Palmitate downregulated Bcl-2 expression compared with control and oleate cultures. (B) Double-stranded-RNA-dependent protein kinase (PKR) inhibition, by PKR inhibitor (6 μM), decreased the expression of Bcl-2.

FIG. 8 presents Western blots showing the effects of Bcl-2 inhibition on NF-κB. Inhibition of Bcl-2 by HA14-1 (10 μM) attenuated the activation of phospho-P65 NF-κB in control, palmitate, oleate and palmitate, oleate co-supplementation cultures.

FIG. 9 illustrates a schematic flowchart for a framework according to various embodiments of the present invention to integrate gene expression and metabolic profile data. The relevancy of each gene to the metabolic function was first evaluated with GA/PLS. Genes with higher frequencies were more relevant to the metabolic function. The frequencies and profile of the metabolic function were then used to constraint the ICA model to extract the independent component that represents the process regulating the metabolic function. The connections between the genes with high coefficients in the independent component were reconstructed with BN analysis.

FIG. 10 illustrates a graphical characterization of constrained independent component analysis according to various embodiments of the present invention. Gene expression data Y was decomposed into independent component structure matrix A and profile matrix S. A was constrained with frequencies of the genes and S was constrained to metabolic function (i.e. the state-dependent metabolite) profile. Terms shown include: yᵢ(t), the expected level of gene i in experiment t, a_{i,j}, which defines the membership of gene i in process j, and Sⱼ(t), the expression profile of process j in experiment t. The relationship yᵢ(t)=a_{i,j}*Sⱼ(t), underlies the relationship y(t)=A*S(t).

FIG. 11 illustrates an exemplary Bayesian network. Gene A is the parent node of Genes B and C, Gene B is the parent node of gene D. Gene B and Gene C are conditionally independent given Gene A.

FIG. 12 presents a flowchart illustrating a representative method for constructing and using a network according to an embodiment hereof, as applied to gene expression data.

FIG. 13 presents a flowchart illustrating a representative method for performing a relevance evaluation of significantly changed genes, in the example of gene expression data analysis, and for obtaining a subset of relevant genes and gene frequencies as measures of their relevance to a given phenotype.

FIG. 14 presents a flowchart illustrating a representative method for performing a constrained independent component analysis of a subset of relevant genes, in the example of gene expression data analysis, and for using the resulting gene weights to identify a narrower subset of top-ranked genes.

FIG. 15 presents a flowchart illustrating a representative method for performing a network construction, using data for top-ranked genes, in the example of gene expression data analysis.

### DETAILED DESCRIPTION

The following description is merely exemplary in nature and is not intended to limit the present disclosure, application, or uses.

The present invention provides an improved method for constructing enhanced models of integrated cell function, based on genomic (transcriptomic), proteomic, and/or metabolomic data, related to a particular phenotype. The response of pathways to environmental stimuli is identified by integrating sets of (static) gene, polypeptide, or metabolite expression profiles and phenotype expression (e.g., dynamic metabolite) profiles. Prior attempts, such as employing Bayesian network analysis alone have required large amounts of data, which are not always available, to reconstruct a model of a whole network of pathways. One advantage of the present invention is that it identifies a subgroup of genes involved in the pathways that are activated in response to environmental stimuli and thereafter reconstructs how this subgroup of genes and pathways are related or connected using Bayesian network analysis. This approach reduces the number of samples required for pathway reconstruction and provides pathway information specific to a cellular function or process. Pathway network models generated by a method according to the present invention are useful for predicting metabolic functions or cellular processes, e.g., quantitative estimates of toxicity induced by contact with a given agent, based upon gene expression profile data.

The approach implemented in a method according to the present invention involves a combination of three steps, illustrated with reference to the example of gene expression analysis:

1. The relevance of each gene to a cellular function (phenotype) is addressed by calculating a relevance value by genetic algorithm-coupled partial least squares analysis (GA/PLS), or an equivalent procedure. Examples of procedures considered equivalent to GA/PLS include: genetic algorithm coupled linear regression, genetic algorithm coupled multi-block PLS, and genetic algorithm coupled non-linear regression), as well as other techniques known in the art. GA/PLS, or equivalent, is used to identify the frequency and hence the relevance of the genes. The genes that are frequently selected by GA/PLS to predict the phenotype are given a high frequency value. Similarly, genes that are not selected by GA/PLS to predict the phenotype are given a frequency value of zero. The frequency is applied as one of the constraints in the next step. This identifies a subset of genes, with high frequencies, that can provide an accurate prediction of the occurrence and/or degree of the cellular function (phenotype).

2. Among these genes, those involved in an independent pathway that regulates the cellular function (phenotype) are selected by constrained independent component analysis (CICA). The constraints are the GA/PLS-assigned frequencies, as determined above, and the metabolic profile of the cellular entity exhibiting the phenotype.

3. Bayesian network analysis (or equivalent network analysis or construction technique) is then employed to reconstruct the pathways using expression profiles of the regulatory genes identified by CICA, thereby producing a network of genes and/or pathways involved in induction of the phenotype.

Thus, in various embodiments of a method according to the present invention, a GA/PLS (or equivalent) analysis is performed on data for genes that are significantly differently expressed concomitant to a difference in phenotype expression level to identify a subset of such genes, followed by a CICA (or equivalent) analysis of the subset to identify a narrow subset of the genes that are determined to be even more closely related to phenotype causation, followed by a BN (or equivalent) analysis on the narrower subset to construct a network of those genes identified as most relevant to phenotype causation.

Each of these three techniques has been used to perform pattern recognition in data, e.g., gene expression data, to identify significant gene expression differences between test samples and control samples or standards and/or to identify gene co-expression or temporal expression relationships among genes. However, the degree to which a genetic and/or metabolic network, resulting from Bayesian (or equivalent) network analysis, can provide predictive accuracy in the relationships of genetic or metabolic elements of a system will determine its usefulness in practice. None of the three approaches has been reported to demonstrate a high level of predictive accuracy. As a result, the present method for constructing networks and the networks provided thereby would be desirable in the art as providing a method for analysis of, e.g., genetic and/or metabolic data that can offer improved putative networks resulting from Bayesian network analysis.

In various embodiments, a method according to the present invention involves the following steps.

1. In a selected cellular entity, identify a phenotype of interest. This can be accomplished, e.g., by obtaining a metabolic profile of, or by otherwise observing, a cellular entity under different conditions. The different conditions can be any that are capable of modifying a chemical or physical property of the entity, e.g., different environments, different treatments, different levels of treatment. In a preliminary step, different cell or tissue types can be observed for their phenotypic response to being contacted with a given compound(s) or condition(s), followed by selection of one of the cell/tissue types and then further obtaining a metabolic profile(s) of the cell's or tissue(s) responses to varying levels of the compound(s). The process can be repeated until a finding is obtained, upon which selection of the phenotype is selected.

The phenotype can be any physical or biochemical property of interest, e.g., a toxicity-associated effect (such as lactate dehydrogenase secretion, or alanine aminotransferase expression), prolonged or shortened cell life, modified cell size or morphology, modified ability to resist infection or impairment, modified ability to colonize an environment, modified ability to compete against or coexist with other cell types, novel metabolite synthesis, altered carbon source utilization preferences, and so forth. Phenotypes can be distinguished from one another to aid in selection of a phenotype of interest. Such distinction can be effected by application of a linear or non-linear Component Analysis (CA) technique, such as: Principal Component Analysis (PCA), Fisher Discriminant Analysis (FDA); non-linear or “kernel” PCA, or non-linear or “kernel” FDA. In one embodiment, production of individual metabolite(s) of a selected cellular entity is observed under varying levels of a toxicity-related condition, e.g., a condition in which toxicity is induced or in which biological detoxification process(es) are induced. In one embodiment, a toxicity-related condition is utilized, wherein the cell or tissue type is preferably a tumor, cancer, and/or liver cell or tissue. The generation of such a metabolic profile for phenotype selection can be performed either before or during the generation of gene expression profiles as described below.

2. In addition to selecting a phenotype of interest, at least two different gene expression profiles of the cellular entity are obtained under conditions in which the entity exhibits a first level of the selected phenotype and a second level of the selected phenotype, and optionally (as a control) in which the entity does not exhibit the phenotype. For example, test 1 (phenotype,+) and test 2 (phenotype +) versus control (non-phenotype) expression profiles and/or test level 1 versus test level 2 expression profiles are obtained. Typically, the gene expression profiles will be transcriptome profiles for the cell(s) or tissue(s) of the entity. The gene expression profiles can be produced by any useful technique known in the art, for example, by mRNA transcriptome analysis using mRNA, cDNA, or cRNA hybridization assay(s), whole transcriptome mRNA, cDNA, or cRNA sequencing, representative transcriptome analysis as by mass spectrometry of mRNA, cDNA, or cRNA fragments, and the like.

3. Identify which genes exhibit statistically significant differences that correlate with induction of the selected phenotype, by application of a component discrimination method to identify a set of altered-expression genes (AE genes). In various embodiments, the component discrimination can comprise employing ANOVA, or an equivalent technique, optionally followed by a Partial Least Squares Analysis (PLS). Examples of equivalent techniques include gene set enrichment analysis (GSEA), parametric analysis of gene set enrichment (PA-GE). The significantly different level of expression that can be so identified includes any of, e.g.: an increased or decrease level of transcription (e.g., an increased or decreased concentration of transcripts), the presence of a transcript not appearing in a control or different-level test sample, or the absence of a transcript that appears in a control or different-level test sample. Such a significant difference is also referred to herein as an expression level that is significantly different in the cellular entity exhibiting the phenotype, i.e. the difference is correlated with the induction of the phenotype.

4. Use GA/PLS (or equivalent technique) to evaluate which of the AE genes are highly correlated with the selected phenotype, assigning higher relevance values to the more highly correlated genes, i.e. the genes whose frequencies in the transcriptome have increased most during induction of the phenotype, or during at least one phase of the induction thereof, e.g., one or more of the earlier phases of phenotype induction. The subset of highly-relevant genes are considered to be closely enough correlated with the selected phenotype to be accurate predictors of the occurrence and/or the level of exhibition of the phenotype, and are chosen as the set of highly-relevant AE (HAE) genes. Those subset of genes having the highest relevance values will comprise at least one, preferably at least 2, and more preferably at least 3 AE genes.

In one embodiment, the set of highest relevance genes will comprise about 90% or fewer of the AE genes, preferably about 80% or fewer, more preferably about 70% or fewer, about 60% or fewer, about 50% or fewer, about 40% or fewer, about 30% or fewer, about 20% or fewer, or about 10% or fewer of the AE genes. Thus, after assignment of, e.g., gene frequencies (relevance values), from 1 gene to about 90% of the most highly relevant AE genes are selected as the set of HAE genes. In many cases, a natural “break” or gap in the series of assigned relevance values can be identified among, e.g., the highest 50%, 60%, 70%, or 80% of the relevant genes. Where such a gap exists, preferably genes having a higher assigned relevance value than that corresponding to such a gap, e.g., higher than the relevance value of the next lowest-relevance valued gene bordering the gap, will be selected.

5. Optionally annotate the AE or HAE genes for function, based on, e.g., published characterization studies, comparison with already-annotated homologous genes (gene ontology), experimental studies, etc., so as to use this information to verify the relevance of AE or HAE genes to the selected phenotype, and excluding from further analysis those whose annotations or other functional identification information indicates they are not relevant to the phenotype.

6. Using Constrained Independent Component Analysis (CICA), with the GA/PLS-assigned relevance values (e.g., gene frequencies) for each of the HAE genes and the phenotype profile, identify a subset of HAE genes involved in a pathway(s) responsible for inducing the selected phenotype, e.g., a set of genes involved in a putative causative pathway(s) involved in producing the selected phenotype. Such a putative, phenotype-causative pathway is also referred to as a “phenotype-expression pathway” or, in some cases, as a “regulatory pathway.” The gene members of such a putative pathway can be referred to as regulatory-function (RF) genes.

7. Using the (Step 2) differential gene expression data for each of the RF genes, perform a Bayesian Network analysis to construct the network(s) of RF genes involved in obtaining the selected phenotype. The network can be stored in computer readable memory.

8. Validate the reconstructed network, or reconstructed pathway(s) thereof, by experimentation to inhibit, prohibit, or enhance transcription or translation of, or post-translational regulation of an expression product of, a gene(s) involved in the reconstructed network, as by use of a gene-specific inhibition, inactivation, or enhancement technique.

### Applicability of Methods According to Embodiments of the Present Invention

Although various embodiments hereof may be, described or exemplified with reference to a class of gene expression data (here, of cDNA concentrations as a measure of transcriptomic data), the novel approach disclosed herein for mining such data can be employed equally well to other sources of biomolecular population data, such as other types of ribonomic data (pre-mRNA concentrations, sRNA, snRNA, snoRNA, scRNA, or miRNA concentrations, and siRNA and/or other post-transcriptional gene control RNA transcript concentrations), as well as genomic data (e.g., nuclear or chromosomal nucleic acid concentrations), proteomic data (cytosolic or other cellular polypeptide concentrations), metabolomic data (small molecule concentrations in cyto), and multi-molecular species data (e.g., polypeptide multimer concentrations, nucleic acid/polypeptide complex concentrations, small-molecule-modified-polypeptide or -nucleic acid compound concentrations, e.g., acetylated,. phosphorylated, or glycosylated polypeptides; methylated nucleic acids, ubiquitinated biopolymers).

Such data can be provided by whole molecule analysis, e.g., whole RNA, cDNA, polypeptide, or multimolecular complex analysis, or by molecular fragment analysis; and can be provided by direct analysis, or by indirect analysis, such as by probe-binding. Useful analytical techniques for these purposes include separation techniques (single and multi-dimensional GC, LC, electrophoresis, and the like), labeling and label detection techniques, polynucleobase polymer hybridization techniques and other binding assays (e.g., aptamer and immunomolecule binding techniques), sequencing and other structure detection or structure analysis techniques (e.g., mass spectrometry, NMR spectrometry, IR or UV-Vis spectrometry), hyphenated techniques (chromatography-electrospray mass spectrometry, chromatography-MALDI-TOF mass spectrometry, and the like), and so forth. These techniques may be employed at any scale and rate, although high-throughput methods and micro-scale (e.g., microarray) analyses are among the methods that are particularly useful for generating such data.

Among the types of biomolecular concentration data, biomolecule profile data is particularly useful. Biomolecule profiles may be prepared by any method known in the art, some examples thereof being: high-throughput metabolomic profiling, such as described in U.S. Pat. No. 6,790,669 to Pfeiffer et al.; high-throughput proteomic profiling, such as described in US Patent Publication No. 2006/0094057 to Hellerstein; high-throughput nucleic acid profiling, such as described in US Patent Publication No. 2005/0095634 to Baker et al.; and nucleic acid-protein complex profiling, such as described in US Patent Publication No. 2004/0096878 to Keene et al.; the relevant teachings of these documents being incorporated by reference.

In various embodiments, the methods employed herein utilize at least two sets of biomolecule concentration data produced by analysis of, preferably identically prepared, biomolecule samples obtained from: two different states of the same or same type of biological entity, which states differ in their level of expression of a phenotype; in some embodiments, at least one additional set of (control) biomolecule concentration data is also utilized, the data being produced by analysis of a, preferably identically prepared, biomolecule sample obtained from the same or same type of biological entity not expressing the phenotype.

In the case of transcriptomic and other gene expression data, the networks constructed by a method according to an embodiment of the present invention will comprise putative genetic pathways, which by inference can provide information about, or can mirror, enzymatic pathways where the genes encode such enzymes. In the case of embodiments using proteomic data, a network can be constructed that comprises putative enzymatic and/or other putative protein-based pathways directly. In the case of embodiments hereof practiced on metabolomic data, a constructed network can comprise “pathways” of, e.g., metabolite pools. Other embodiments will become apparent to one of ordinary skill in the art upon reading the disclosure, examples, and claims hereof, and all such embodiments are intended to fall within the scope of the present invention.

### Sources of Biomolecular Data for Analysis

Cellular entities useful for providing samples for biomolecule concentration analysis can be any cell, collection of cells, cell fusion, or biomolecule-containing cell fragment. Some examples of these include: organism(s), organ(s), tissue(s), cell(s), protoplast(s), spheroplast(s), organelle(s), cytoplast(s), nucleoplast(s), and the like. Such biological entities can be, e.g.: wild-type or domesticated; uncultivated or cultivated/cultured; non-hybrid or hybridized/fused; native or recombinant; uninfected or pathogen-infected. The whole or part(s) thereof can be provided as samples for use in a biomolecule concentration analysis. Thus, in an analysis according to an embodiment of the present invention, data are being compared from at least two samples that differ from one another in one significant way: their degree of expression of a given phenotype (or set of phenotypes). Preferably, they will differ in only this way.

Examples of useful states of a biological entity that provide, e.g., phenotype-low-expressing and phenotype-high-expressing, samples for biomolecule concentration analysis include, but are not limited to: preliminary and progressed disease states (e.g., early detected versus entrenched cancer), hyperproliferative/benign and metastatic states, treated and untreated states, induction and established states (e.g., induction of apoptosis and progression of apoptosis), short-term-post-treatment and long-term-post-treatment states, treatment type 1 and treatment type 2 states, different states of cell differentiation, juvenile and mature states, and so forth. As used in this context, treated and untreated states can be any (non-control) states of a biological entity in which a given phenotype is expressed, the “treated” state being such a state in which a physical, chemical, or biological agent or condition has been applied to the entity, and which expresses a degree of the phenotype that differs from the degree to which the phenotype is expressed in the “untreated” state, i.e. in which the agent or condition has not been applied to the biological entity.

In some embodiments, the compared states can be different positional states, e.g., central versus peripheral location of microbial colony cells, leaf-versus root-location of plant parenchyma cells, gut-versus cranial-location of animal endothelial cells, and so forth. In some embodiments, data can be compared for samples from different, but homologous, biological entities having approximately the same metabolic state, such as, e.g., the same cell type from two different varieties or subspecies of the same species or from two different species of the same genus, or from a purebred parent and a hybrid offspring or from a parent and a recombinant offspring; in such a comparison, the samples can be said to differ from each other in their states of genetic or evolutionary divergence. Thus, in all cases, different states of biological entities can be compared.

Examples of phenotype data useful in various embodiments hereof include: the rate or amount of production, accumulation, degradation, and/or release: (1) of a given biomolecule, e.g., a given metabolite, polypeptide, or nucleic acid, or an alternatively spliced or alternatively folded or alternatively modified form of a polypeptide or nucleic acid molecule; (2) of a given class or subclass of biomolecules, such as all or some of a cell's, e.g., terpenoids, steroids, phenylpropanoids, flavonoids, stilbenoids, catecholamines, alkaloids, fatty acids, porphyrins, pigments; serine proteases, cytochromes; srRNAs; or (3) of a given macromolecular biological assemblage or type of assemblage, e.g., ribonucleoparticles, multi-polypeptide proteins, nucleic acid duplexes, triplexes, or quadruplexes. Other useful phenotypes include, e.g.: coloration variants, such as variegated, striped, or spotted phenotypes; dwarfing or giantism; or other morphological or behavioral differences from a parental or wild-type form. Thus, a given phenotype and/or its degree of expression can be identified through chemical analysis or by visual observation. The phenotype data for use in various embodiments hereof can be qualitative (e.g., small, medium, large), quantitative (e.g., μg/mL concentration, mm length), semi-quantitative (e.g., estimated degree of coloration of about 2, 5, 7, and 8 on a scale of 10), or comparative (e.g., a highly expressed phenotype data can be three-times that of, or about 50% more than that of, a low-expressed phenotype).

As used herein, unless otherwise stated or indicated by context, a “metabolite profile” (used alone or in a phrase such as “metabolite profile data”) refers to the behavior of one or a selected subset of metabolites in relation to the phenotype states being studied in an embodiment hereof, e.g., an increase or decrease in concentration of the metabolite(s) that is concomitant with the change in phenotype-expressing state. Such a profile can be referred to as a “dynamic” metabolite or metabolomic profile. A parallel meaning would apply, e.g., to such terms as “nucleic acid profile” and “polypeptide profile.” Also, unless otherwise indicated (expressly or by context) terms such as “metabolomic profile,” “genomic profile,” or “proteomic profile” as used herein refer respectively to the concentrations of metabolites, nucleic acids, or polypeptides, generally, in any one state of a biological system. Such a profile can be referred to as a “static” profile or a thumbprint. In various embodiments, gene expression data used as a starting point for analysis in a method hereof can be genomic profiles, e.g., transcriptomic or ribonomic profiles, obtained from two different phenotype-expressing states of a biological entity; the metabolite profile, i.e. the different concentrations of only one or a few metabolites, which concentrations are different in each of the states studied, will be used in an analysis according to the present invention. The metabolite profile data can be obtained from targeted analytical chemical analysis of pre-selected metabolites, or can be obtained from a set of metabolomic profiles showing differences between states.

### Flowchart Example of a Method According to Embodiments of the Present Invention

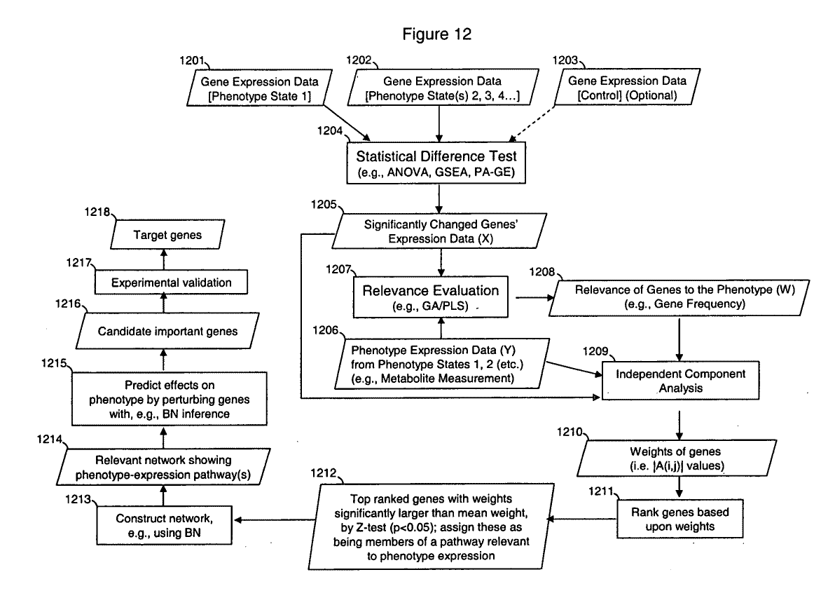

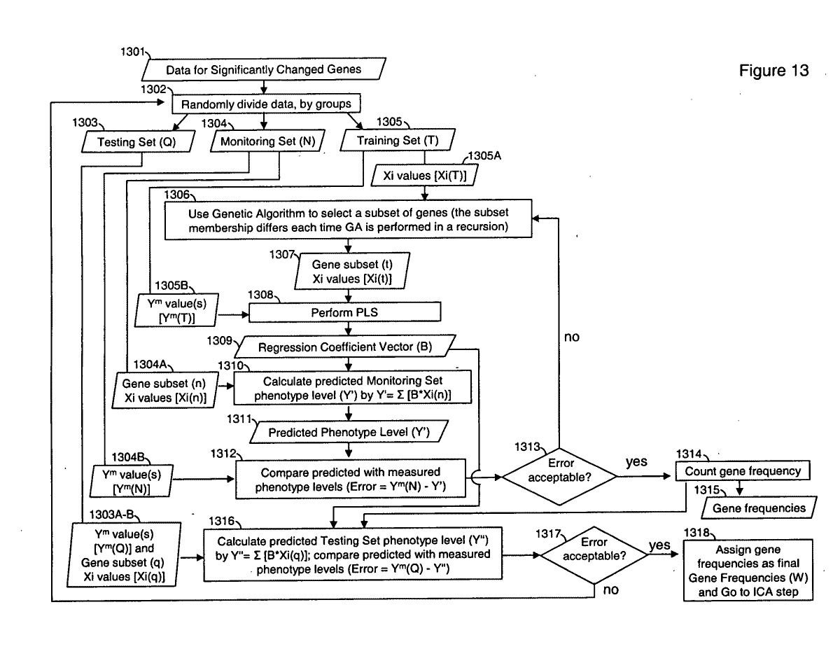

Exemplary methods for network construction and use are further exemplified with reference to FIGS. 12-15. An exemplary process for construction of an improved network according to an embodiment of the present invention is illustrated in FIG. 12, and FIGS. 13-15, as applied to gene expression data. In the illustrated example, gene expression data are provided for at least two levels of phenotype expression (phenotype states), and optionally for a phenotype-negative control (1201-1203, respectively). These can be provided, e.g., as static transcriptome (mRNA or cDNA) profiles for each phenotype state. The gene expression data will be provided for at least four analyzed groups of cellular entities; a replicate or set of replicate samples can be the basis for a group. Thus, where only two phenotype-expressing states are to be analyzed, i.e. without a phenotype-negative control, a replicate of each can be used to provide two additional groups (or two replicates of one of the phenotypes can be used), in order to obtain at least four data groups. The expression data for each expressed gene can be provided as the logratio of its expression level (amount, concentration, etc.) over its expression level in a control sample or average control, or over its expression in a (e.g., arbitrarily) selected phenotype-expressing group or average group, used as a control proxy, where that group is used to normalize all of the gene expression data; this can be expressed as Xi=[log(Test)/log(Control)].

At least one measure of the phenotype expression level is provided for each group, and this can be any feature of the cellular entity that varies (absolutely, or directly or inversely proportionately) with the level of expression of the phenotype in the different states to be analyzed (1206). More than one measure of the phenotype expression level can be used, e.g., any measure(s) of one or more of the physical properties (size, morphology, et al.), biochemical properties (e.g., levels of biomolecule synthesis, processing, or secretion), chemical properties (e.g., salinity, pH, inorganics absorption/sequestration, and the like), behavioral characteristics (e.g., such as motility, feeding or mating/reproduction pattern, and association with other cells or organisms).

The expression data for each phenotype of a group of samples can be provided as the logratio of its expression level (amount, concentration, etc.) over its expression level in a control sample or average control, or over its expression in a (e.g., arbitrarily) selected phenotype-expressing group or average group, used as a control proxy, where that group is used to normalize all of the phenotype expression data of the same type (e.g., same property); this can be expressed as Y^{m}=[log(Test)/log(Control)].

A statistical differencing test (1204, e.g., ANOVA, GSEA, PA-GE, or an equivalent technique) is used to identify, from the gene expression data (1201-1203), those genes whose expression is significantly different. For example, see S-Y Kim & D J Volsky, PAGE: Parametric Analysis of Gene Set Enrichment, BMC Bioinformatics 6:144 (2005) (doi:10.1186/1471-2105-6-144); and for Gene Set Enrichment Analysis (GSEA), see V K Mootha et al., PGC-1-responsive genes involved in oxidative phosphorylation are coordinately downregulated in human diabetes, Nature Genetics 34:267-273 (2003) (Epub. 15 Jun. 2003; doi:10.1038/ng1180). The resulting set of genes (1205) can also be referred to as a set of “altered expression” genes (AE genes).

The gene expression data (1205, e.g., Xi values) for the AE genes, and the sample group phenotype expression data (1206, e.g., Y^{m}), are then analyzed by a relevance evaluation (1207, e.g., GA/PLS or an equivalent technique, optionally supplemented with gene annotation data provided via a fitness function as an additional factor in the GA/PLS, or optionally supplemented with a step of eliminating genes based on gene annotation data, which step is performed either before or after GA/PLS) to provide both (1) a subset of significantly changed genes whose change in expression correlates well with the change in phenotype expression level between or among states (which can also be called HAE genes), and (2) a calculated relevance level (1208, e.g., gene frequency (W)) for each gene in the subset. The relevance value of a gene is proportional to its degree, e.g., frequency-based, correlation with the phenotype; this value can be an actual count of the gene copy number, the number of times the gene is selected, the concentration of the gene, or the calculated level of significant o the gene, or such a measure multiplied by a factor (e.g., a constant), if desired.

The gene expression data (X values from 1205) for each of the genes in that subset, the phenotype expression data (Y values from 1206), and relevance level (1208 (W)), are then used in an Independent Component Analysis (1209) to provide weights for each gene of the subset, which weight values (1210) reflect the apparent degree of prevalence of each gene in relation to the phenotype. These weights are used to rank the genes (1211) and to calculate a mean weight that is used in a Z-test (1212) to identify genes weighted significantly greater than the mean and these are categorized as Top-Ranked genes; the Top-Ranked genes are then assigned as being members in a pathway relevant to phenotype expression. Top-Ranked genes can also be referred to as “Regulatory Function” (RF) genes.

Expression data for each of the Top-Ranked genes is then analyzed by Bayesian network analysis (or an equivalent network analysis technique) to construct a network of the top-ranked genes (1213).

Once such a network (1214) has been provided, it can be reviewed to identify, e.g., nodes (genes in this example; polypeptides or metabolite pools in other exemplary uses) that were previously unknown to be involved or that were not considered particularly important, in causation of the phenotype. The network can be used to predict (1215) the effect of perturbing a gene (or other biomolecular entity represented by a node) in order to guide the selection of genes (node entities) that are candidates for being important genes in causation (effectuation) of the phenotype (1216). Perturbations can then be experimentally performed to exclude or validate the candidate(s) (1217) and thereby identify gene(s) (or other biomolecule(s)) that can be used as targets (1218) for, e.g., drug development, other phenotype manipulation strategies, further research, and so forth.

Details involved in 1205-1209 (FIG. 12) of this gene expression example are set forth in FIG. 13, wherein a GA/PLS technique is exemplified for the relevance evaluation. Data for the difference-test-identified significantly changed genes (1301), in each of four sample groups (phenotype level 1; phenotype level(s) 2, 3 . . . ; replicate(s); control(s)) comprising data for two phenotype expression levels, will include expression data for each gene in each group (e.g., Xi values) and group phenotype expression data (e.g., Y^{m}). The four or more groups are then randomly divided (1302), by groups, into three data sets: a Training Set “T” (1305), a Monitoring Set “N” (1304), and a Testing Set “Q” (1303). The Training Set gene expression data (1305A, e.g., Xi values, Xi(T) for all groups in “T”)) is analyzed by a Genetic Algorithm (1306) to identify a subset of genes whose expression data (1307, e.g., Xi values, Xi(t), for all groups in “T”); with lower case, “t”, indicating the subset of “T”) are then used in a Partial Least

Squares analysis (1308), along with the phenotype expression data (1305B, e.g., Y^{m} value(s)) from each of the group(s) populating the Training Set (Y^{m}(T)). In general, the PLS involves solving the equation

Y^{m}=b1*X1+b2*X2+b3*X3 . . .
for b1, b2; b3, and so forth, and these b values (regression coefficients) are then used to derive a regression coefficient vector, B (1309), according to the relationship:

$$\vec{B} = [ \begin{matrix}b 1 \\ b 2 \\ b 3 …\end{matrix} ]$$

Gene expression data obtained from the Monitoring Set (1304) for the same subset of genes already identified by GA, are then provided (1304A, e.g., Xi values, Xi(n)), and these are used, along with the B vector (1309), to calculate (1310) a predicted level of phenotype expression for the Monitoring Set (1311, Y′), by solving the equation

Y=b1*X1+b2*X2+b3*X3 . . .

for Y (as a one-component vector), or the relationship

$$\vec{Y} = [ \begin{matrix}Ya \\ Yb\end{matrix} ] = [ \begin{matrix}X 1 a & X 2 a & X 3 a \\ X 1 b & X 2 b & X 3 b\end{matrix} ] * [ \begin{matrix}b 1 \\ b 2 \\ b 3 …\end{matrix} ]$$

for Y (as an at least two-component vector). The resulting predicted phenotype expression level (Y′) is then compared (1312) against the measured expression level for the Monitoring Set (1304B, (Y^{m}(N)) to determine an Error value according to Error=Y^{m}(N)−Y′.

This Error, referred to as a prediction error, is then assessed to determine if it has been minimized, e.g., as by use of an R² (goodness of fit) measure and a decision (1313) is based thereon regarding how to proceed; for example, the Error minimization can be done according to the procedure set forth in C. Chan et al., Application of Multivariate Analysis to Optimize Function of Cultured Hepatocytes, Biotechnol. Prog. 19(2):580-598 (2003).

If the error is determined to not be acceptable (e.g., not minimized or not sufficiently minimized), then the Genetic Algorithm (1306) is again employed to select a subset of genes from the Training Set, which subset has membership different from that of the prior subset(s), although different memberships can include one or some of the same individual genes. Then, 1307-1313 are again performed using data for the new gene subset.

If the error is determined to be acceptable, then a value for the relevance of each of the gene members of the gene subset are obtained, e.g., by counting (1314) the frequency of each gene to obtain gene frequencies (1315). Also, a further predictive calculation and comparison is then undertaken (1316) using data for the subset genes, taken from the Testing Set (1303A-B: (Y^{m}(Q) and Xi(q)), and vector B (1309), performed as described above for 1310-1312, but solving the equations for a predicted level of phenotype expression for the Testing Set (Y”) and determining the Error value according to Error=Y^{m}(N)−Y″.

This error, also a prediction error, is assessed as described above for 1312-1313, and a decision (1317) is based thereon as to how to proceed. If the error is determined to not be acceptable (e.g., not minimized or not sufficiently minimized), then the data (1301) are again randomly divided (1302), by groups, to form the three Sets (1303-1305) and the process (1306-1317) is again performed using the data from those newly formed Sets.

If the error is determined to be acceptable, then the relevance values (1315, e.g., gene frequencies) are assigned (1318) as the final gene frequencies (W) and these are used as inputs into the Independent Component Analysis (ICA).

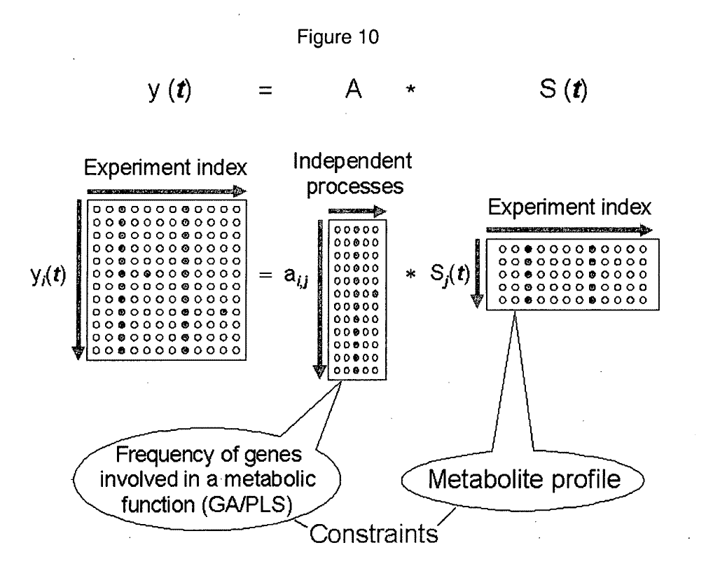

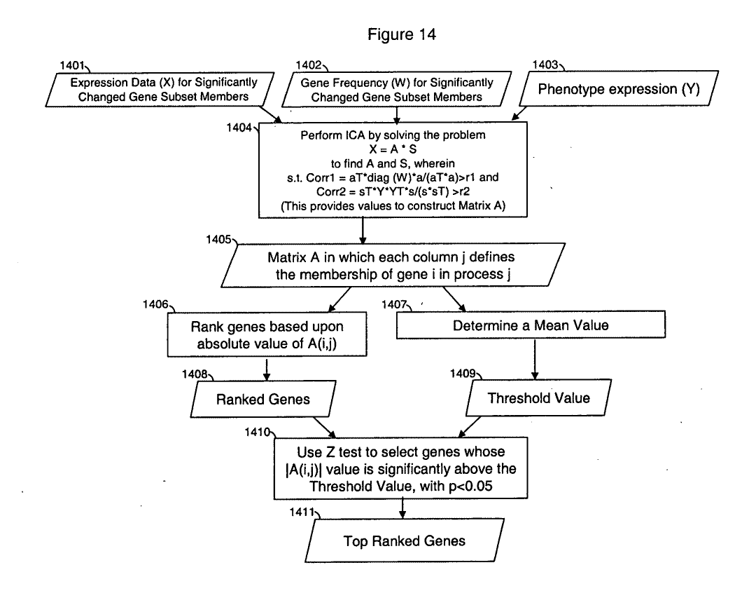

Details involved in 1209-1212 (FIG. 12) of this gene expression example are set forth in FIG. 14, which illustrates ICA and subsequent selection of Top-Ranked genes. Expression data (X) for each gene that is a member of the final GA-generated gene subset (1401; see FIG. 13 discussion above), along with its relevance value (1402, e.g., gene frequency (W)) value, and the corresponding sample groups' phenotype expression level data (1403, e.g., Y), are input into the Independent Component Analysis (1404) to generate weight values for each of these genes, which s are used to populated a Matrix A (1405), as schematically illustrated in FIG. 10. The weight values are used to rank the genes (1406) to obtained ranked genes (1408), and they are also used to determine a mean weight value (1407) that is then used as a threshold value (1409). A Z-Test (p<0.05) is then employed (1410) to select those genes whose weights are significantly greater than the threshold value, and those genes whose weights are determined to be significantly greater than the threshold value are assigned as the Top-Ranked genes (1411).

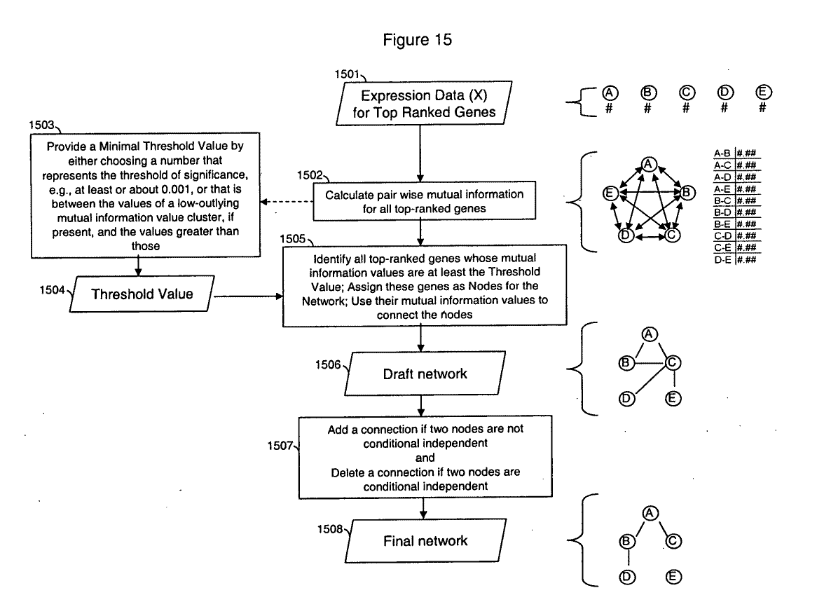

Details involved in 1213-1214 (FIG. 12) of this gene expression example are set forth in FIG. 15, which illustrates construction of a network of putative phenotype-expression pathways utilizing, e.g., Bayesian network analysis. Expression data (X) for the Top-Ranked genes (1501) are used to calculate (1502) pair-wise mutual information for every possible pair. A threshold value (1504) is provided, e.g., by choosing a value that represents a minimum level of significance (e.g., at least or about 0.001) for pair-wise information values, or by identifying a low-outlying cluster of pair-wise information values and setting the threshold value between that cluster and the values greater (1503).

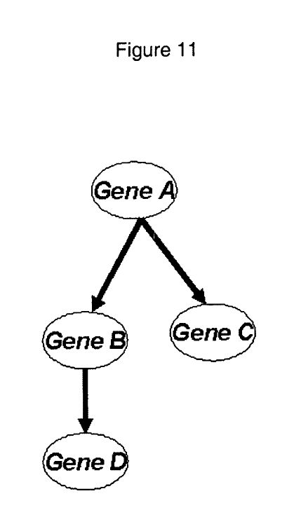

All top-ranked genes whose mutual information values are greater than the threshold value are then identified (1505) and these are assigned as nodes for the network and their mutual information values are used to connect the nodes (1505) to provide a draft network (1506). Changes are then made (1507) to the draft network by adding a connection (e.g., an “edge”) if two nodes are found to b e not conditional independent, and by deleting a connection (e.g., an “edge”) if two nodes are found to be conditional independent, to thereby form a final network (1508), such as the one illustrated in FIG. 11. Network-based prediction and validation of potential target genes can then be undertaken, starting from the constructed network.

As used herein in reference to construction of networks of connected nodes, the term “functionally adjacent” refers to any type of relationship occurring in cyto in which a biomolecule represented by a node in a biomolecule network (e.g.: a polypeptide in a polypeptide, e.g., enzyme, network; a nucleic acid in a nucleic acid, e.g., gene, network; or a metabolite in a metabolite pool network), e.g., operates immediately upstream from, operates immediately downstream from, operates jointly with, is an immediate precursor to, is an immediate derivative of, directly activates, directly deactivates, directly modulates, or otherwise directly regulates the activity of another biomolecule represented by a node in the network.

### Validation Techniques for Gene Networks

Examples of useful gene-specific inhibition or inactivation techniques include:
1) Gene knockout techniques, such as insertion or deletion mutation in an open reading frame or regulatory region of a gene to make the gene untranscribable, untranslatable, or encoding a non-functional expression product; or whole gene deletion;
2) Gene knockdown techniques, to interfere with transcription and/or translation to reduce or eliminate gene expression, such as: RNAi techniques, e.g., using siRNA; antisense RNA techniques, e.g., using antisense RNA transcription from recombinant genes, using morpholino antisense oligonucleotides (e.g., phosphorodiamidate morpholino oligonucleotides), or using antisense nucleic acid analogs, such as peptide nucleic acids (including 2-aminoethyl glycine-methylenecarbonyl-nucleobase polyamides, hydroxyprolinephosphate polyamide NA analogs, and others); or dominant negative RNA techniques; and
3) Gene inhibitor techniques.

Examples of useful gene-specific enhancement techniques include:
1) Gene supplementation: transfection with additional copies of the gene to increase the concentration of the expression product in the cell;
2) Gene regulatory region replacement, e.g., with a stronger promoter, with a constitutive promoter, etc.;
3) Gene regulatory protein modulation, such as by transfection, e.g., with additional copies of an activator protein gene, with a highly expressed activator protein gene, with a constitutively expressed activator protein gene; or by gene knockout or knockdown of a repressor protein gene;
4) Gene expression product post-translational regulatory enhancement, e.g., enhancement of a cellular post-translational processing system, pre-protein peptide cleavage system, substrate supply, or inhibitor removal process such as a removal or degradation of a feedback-inhibiting product; and
5) Chemical activators.

Although, in a preferred embodiment, the validation process utilizes whole cells, a validation can alternatively be performed in vitro in cell lysate, in cytoplasmic lysate, in cell or cytoplasmic lysate containing karyoplasts and/or a cell-free expression system (e.g., a reticulocyte lysate or wheat germ translation system). The differences can be analyzed, e.g., by metabolomic analysis using chromatography, expression profiling using gel electrophoresis or chromatography followed by mass spectrometry (e.g., MALDI-TOF MS), or can be analyzed or monitored using NMR, or any other technique known useful therefor in the art.

Gene inactivation (e.g., knock-outs) and genetic manipulation and translation interference and gene silencing methods can be used for validation of candidate polypeptide targets identified from a polypeptide network constructed according to various embodiments hereof. Enzyme inhibitors can be used in some cases, as can polypeptide binding or sequestering agents, e.g., anti-candidate-polypeptide antibodies, aptamers, and the like. In the case of metabolite (or metabolite pool) networks, manipulations of enzymes known to catalyze the synthesis or degradation of a metabolite can be used to validate a candidate metabolite, e.g., enzyme overexpression, enzyme-encoding gene inactivation or inhibition or activation, and similar techniques can be used, to increased, decrease, or eliminate the pool of a given candidate metabolite. In some cases, metabolite binding or sequestering agents may be available for a candidate metabolite, and these can be used for validation.

The result of implementing a method according to various embodiments of the present invention is thus a validated reconstructed network that is useful for a variety of purposes, such as those described below.

### Uses

The steps of a method according to the present invention, which results in provision of a validated reconstructed network can further comprise a step of using the network to elucidate or predict a phenotype. For example a practitioner can utilize the validated reconstructed network to establish the molecular basis of toxicity of a given compound (e.g., as for FDA data submission), or the molecular basis of any other phenotype response, e.g., the molecular basis of a therapeutic effect; or utilize it to identify a drug target, such as by identifying a bottleneck (node) gene or a gene necessary for production of the phenotype, which can then be used to screen a library of compound(s). The screening step can involve screening the base sequence, base pair sequence, or higher-level structure of the identified gene (in the form of a nucleic acid or nucleic acid analog) or an expression product of the identified against, a library of compounds to identify compounds that can bind thereto.

A method according to the present invention allows the practitioner to more readily quantify and predict the effect of a given environmental stimulus (including the in vivo environment) or the effect of alteration in the activity of a given gene or expression product thereof, on any other gene or expression product thereof in the network, as well as the phenotype and overall metabolism and response of the cell or tissue. Examples of practical applications of the method include the following.

A network constructed according to a method of the present invention can be used to assist in diagnosis and prognosis of medical conditions. For example, a practitioner can quantitatively predict the amount or rate of fat (triglyceride) accumulation in the liver, as occurs in steatosis, which is indicative of the patient's predisposition to develop steatohepatitis and/or cirrhosis. A network according to the present invention can utilize actual (measured or estimated) or hypothesized patient-specific factors, such as, e.g., diet, alcohol use, drug and supplement regimen, efficiency of lipolysis, personal genetic analysis, and personal enzyme variants or defects that may result from the patient's translational or post-translational systems, to provide such a quantitative prediction. Thus, the network can be used to predict a patient's predisposition for, and rate of developing a condition or disease, based on reported or posited exposure to various inducing agents.

The network can be used to develop or evaluate drugs to improve a metabolic, cellular, or tissue function, e.g., by identifying gene(s), and/or their expression product(s), to target in order to improve the level of their activities, such as to improve the level of expression or activity of enzyme(s) involved in a desirable biocatalytic activity.

The network can be utilized to more efficiently establish the molecular basis of toxicity of a given compound (e.g., as for FDA data submission), or the molecular basis of any other phenotype response, e.g., the molecular basis of a therapeutic effect or the molecular basis of a disease mechanism or of the development of a medical condition.

The network can be utilized to identify a drug target, such as by identifying a gene (or its expression product) that occupies a node of the constructed network, or by otherwise identifying a gene (or its expression product) necessary for production of the phenotype. The target so identified can then be used to screen a library of compound(s). The screening step can involve screening the base sequence, base pair sequence, or higher-level structure of the identified gene (in the form of a nucleic acid or nucleic acid analog) or an expression product of the identified gene, against a library of compounds to identify compounds that can bind thereto.

The network can also be used to identify other compounds or conditions, related to the compound(s) or condition(s) used to induce the phenotype for testing, which are at least suspected of having similar effect(s) thereto. Likewise, the network can be used to predict the effect of supplementing the cell or tissue with, or reducing therein or withholding therefrom, an amount or concentration of substrate used by an expression product of a gene of the network; or of perturbing one or more genes of the network, e.g., replacing a gene expressing a given enzyme with a modified gene expressing another enzyme having greater or lesser degree of the enzymatic activity. Compounds and substances so identified can comprise a library that can be screened against a drug target that is a gene, or its expression product, of the pathway network.

The improved network allows quantitative predictions to be made, rather than merely qualitative predictions, of the effect of perturbing the cell or tissue, so that further experimental work can be done more efficiently. For example, where only a qualitative prediction of the synthesis of a given compound is made, the presence of that compound merely provides a positive result for the test, i.e. a blanket confirmation of the hypothesis being tested. However, where a quantitative prediction is made, as is possible utilizing a network according to the present invention, the detected amount of the compound—e.g., whether lesser or greater than the predicted amount—provides greater information that can then be used to further refine the network model. In contrast, providing such a refinement to the model, in the case of the former (qualitative) type of test, would require yet further testing.

The embodiments and examples as described herein are not intended to limit the scope of the invention, which is defined by the following claims, as construed under applicable law, including the doctrine of equivalents.

### EXAMPLES

A method according to the present invention is implemented on a computer using the technical computer programming language MATLAB (from The MathWorks, Inc, Natick, Mass., USA).

### Examples Overview: A Systems Approach that Reconstructs and Predicts Pathways that Confer a Cellular Phenotype by Integrating Gene Expression and Metabolic Profiles

Cellular systems are controlled by interconnected signaling and regulatory networks. Elucidating the underlying pathways would facilitate identifying therapeutic targets and predicting toxicity prior to pre-clinical and clinical trials. Gene expressions, proteins and metabolites can be profiled for a cellular state. A systems approach can assist the integration of these different high-throughput data to infer the underlying pathways. In this paper, a systems approach was developed to integrate gene expression and metabolic profiles to identify pathways related to a cellular function, such as liver toxicity. The approach first selects genes relevant to a metabolic function with genetic algorithm coupled partial least squares analysis and independent component analysis; and then reconstructs the pathways from the selected subset of genes with Bayesian network analysis.

We applied the approach to investigate cytotoxicity related pathways in a human hepatoblastoma cell line (HepG2/C3A). In this cellular system, saturated fatty acids and acute TNF-α exposure were found to be cytotoxic, although chronic TNF-α exposure was found to be cytoprotective. Genes encoding biomolecules in pathways involved in regulating cytotoxicity were selected and the pathways were reconstructed. A classifier was constructed based upon the learned network structure to predict cytotoxicity from the gene expression profiles. Genetic perturbation was simulated in the classifier to identify the effects of a select group of genes on the cytotoxicity, as well as on other genes within the network. Finally, several pathways were experimentally validated by perturbing the pathways and measuring their protein levels.

### Introduction

The quality of life of millions of people is severely compromised due to the loss of cellular function resulting from injury, disease or simply aging. The regulation of cellular function is generally achieved through the contribution and interactions of genetic, signaling, and metabolic pathways. Therefore, understanding the biological function of countless genes and how these genes and gene products interact and regulate each other to yield a functional cell would help to identify more appropriate pathways that should be targeted or investigated for a given disease.

Genome-wide information, such as gene expression, protein-protein interaction, protein-DNA interaction, are allowing for a more comprehensive characterization of the cellular phenotype. These wealth of data make possible the identification of genes, proteins, and pathways that can be involved in producing a phenotype. Two types of approaches have been taken to integrate multi-level biological data for the purpose of identifying the relevant genes and pathways. The first approach reconstructs pathways from measurements of gene expression and molecular interaction data, such as protein-protein and protein-DNA interactions. For example, gene regulatory [Lee et al. 2002] and signal transduction [Steffen et al. 2002] networks have been reconstructed from gene expression data coupled with either protein-DNA or protein-protein interactions, respectively. The availability of genome-wide protein-protein and protein-DNA interaction measurements, however are limited in mammalian systems. Therefore, a second approach has been taken to infer pathway information from gene expression and metabolic data of cells systematically exposed to different environments, which captures the observed cellular responses induced by the underlying regulatory networks.

This approach assumes the information about the regulatory networks is contained within these profiles. A typical approach is to identify co-regulated genes by clustering genes with similar expression [Eisen et al., 1998]. However clustering does not reveal a pathway that can be experimentally tested. Methods such as Boolean network [Akutsu et al. 1999] and Bayesian network (BN) [Friedman 2004] analysis have been applied to infer gene regulatory networks, although they are computationally inefficient when applied to large size network with thousands of genes. Only part of the network is perturbed (active) when cells are subjected an environmental stress. The active sub-network has a smaller size and it reveals the pathway that was induced by environment condition. It is therefore the objective of this paper to reconstruct the active pathways to get a better understanding how the cellular functions are regulated.

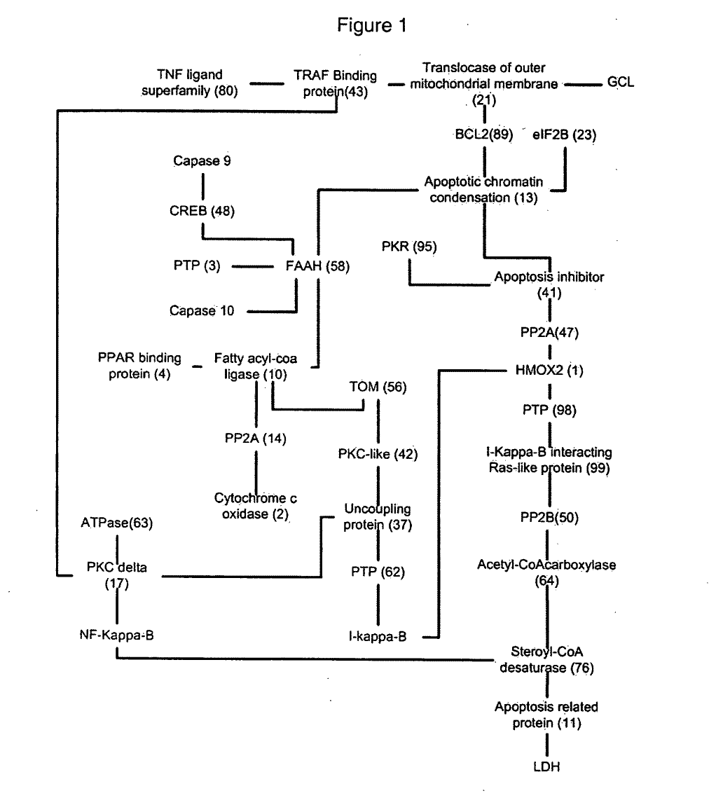

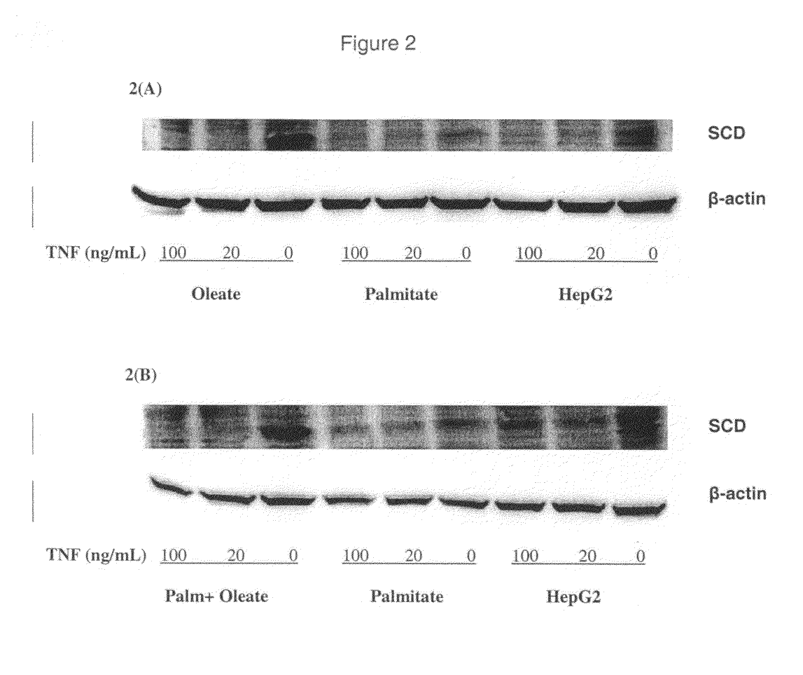

The paper illustrated an approach that integrates gene expression data with a cellular (or metabolic) function, namely, lactate dehydrogenase (LDH) release to identify the pathways involved in producing a cellular phenotype. First we apply genetic algorithm coupled partial least square analysis (GA/PLS) [Li and Chan 2004a] and independent component analysis (ICA) [Liebermeister 2002] to identify a subset of genes that can be involved in a cellular process. We assume, as a first approximation, that the cellular (or metabolic) function can be predicted from the expression level of a subset of genes that are involved in the function. GA/PLS selects a subset of genes based upon the assumption that a cellular function (e.g., urea production [Li and Chan 2004a]) can be determined in part by the enzymes that catalyze the reactions involved in this cellular function, and the activity of these enzymes (proteins), in turn, the metabolite produced are determined in part by the gene expression level of the enzymes (proteins). An illustration of this idea is shown in FIG. 1 below.

The genes selected by GA/PLS were corroborated with the literature to identify known interactions and analyzed by gene ontology to identify known functional associations. Thus, GA/PLS was used to determine the relevancy of genes and thus the frequency (phenotype relevance value) of each gene in the subset. With the frequencies and the LDH profile as constraints, ICA extracts an independent component from the gene expression data. ICA assumes that the expression profile of thousands of genes can be represented by a reduced number of mutually independent processes. The genes with weights significantly different from zero were identified as the genes involved in the independent process. Finally, Bayesian network (BN) analysis was applied to reconstruct the pathways from the expression profile of the selected genes. The reconstructed network of pathways provides potential mechanisms on how palmitate induces LDH release. The pathways reconstructed by the model were experimentally tested to evaluate the validity of the connections. The reconstructed Bayesian network can be used to predict the cellular function based upon gene expression, which makes possible the simulation of artificial genetic perturbation (over-expression or silencing) and predict its effects on the other genes and the cellular function.

The framework was applied to identify pathways that are involved in palmitate induced cytotoxicity in human liver cells. Free fatty acids (FFAs) and tumor necrosis factor alpha (TNF-α) have been shown to be involved in the pathogenesis of liver disorders, such as fatty liver disease and steatohepatitis. Quantification of genetic responses of the hepatocytes to physiologically elevated levels of fatty acids and TNF-α can provide insight into the physiological actions of these metabolites. Gene expression and LDH release profiles, the latter characterizes cell death, were measured for HepG2/C3A cells exposed to different types of FFAs and TNF-α. We applied the framework to identify the pathways involved in palmitate-induced cytotoxicity. The validity of the reconstructed pathways was tested by perturbing elements within the pathways and measuring the changes in the protein expression levels. Finally, the BN network was used to simulate the network and the effects of perturbing genes, e.g. stearoyl-CoA desaturase and Bcl-2 on LDH release and other genes were predicted using the model. The results illustrate that the integration of gene expression data and cellular function by our framework provides informative and testable hypothesis on the mechanism(s) of palmitate-induced cytotoxicity.

### Results

1. Identifying Genes Relevant to Cytotoxicity or LDH Release Using GA/PLS.

A two step ANOVA analysis was performed to identify the genes that changed significantly due to FFA or TNF-α exposure. We identified a list of genes from the literature that are relevant to palmitate-induced cytotoxicity and applied (supervised) ANOVA with P≦0.05 to this list of genes, which can be found at www.chems.msu.edu/fac.pub/chan/imptgenes.zip. In addition, (unsupervised) ANOVA analysis was applied to the entire list of genes with P≦0.01. The two lists of genes were then combined into one list, eliminating any overlaps between the lists. Using the supervised and unsupervised ANOVA tests, the expression level of 830 genes were found to be significant due to either TNF-α or FFA. This list of genes is available online at www.chems.msu.edu/fac.pub/chan/anovaresult.zip.

The GA/PLS algorithm determined the relevancy of each gene to LDH release by counting the frequency with which each gene was selected by GA into a subset of genes used to predict LDH release [Li & Chan 2004a]. The frequency can be found online in a table at www.chems.msu.edu/fac.pub/chan/gaplsresult.zip. The genes identified by GA/PLS to be relevant to palmitate-induced cytotoxicity, as measured by LDH release, included the following (with representative Genbank Accession Nos. indicated): oxidative stress-related genes, e.g., glutathione peroxidase (AA664180); apoptosis-related genes, e.g., caspase 8 (AA44868), Bcl-2 (AA446839); TNF-related genes, e.g., TNF super-family (AAA77863); mitochondria membrane permeability-related genes, e.g., translocase of outer membrane (TOM)-34 (AA457118); ceramide-related genes, e.g., acidic sphingomyelinase (AA676836), sphingosine kinase (AA630354)), translational related genes (e.g., eIF2β (AA027240); and signal cascade-related genes, e.g., protein phosphatase 2A (AA490473) and PKC-δ (H11054).

The profiles of each group of genes are available online at www.chems.msu.edu/fac.pub/chan/geneprofile.zip. The relevance of these genes to palmitate-induced cytotoxicity was confirmed through a literature search. In brief, identification of the reactive oxygen species (ROS) related genes indicated the involvement of ROS in the palmitate induced cytotoxicity, which was supported by elevated ROS levels in the palmitate cultured cells [Srivastava & Chan, submitted]. Factors such as TNF-α mitochondria membrane permeability, ceramide metabolism, translation, protein phosphatase (e.g. PP2A) and kinases (e.g. PKC) have been found involved in apoptosis [Srivastava & Chan, submitted]. Based upon the expression of the selected genes, a quantitative phenotypic model was constructed to predict LDH release [Li & Chan 2004a].

2. Identifying Genes Involved in an Independent Pathway Related to Cytotoxicity Using ICA.

GA/PLS determined the frequency with which each gene was selected to predict LDH release. This frequency and LDH release profiles were applied as constraints in ICA to extract an “independent component” from the gene expression profile. The independent component in this case identified a subset of genes whose profiles corresponded to the LDH release profile. ICA determined the weights for each gene by minimizing the mutual information between independent components. The weights determined by ICA are available online at wwvv.chems.msu.edu/groups/chan/ICAweights.zip. Genes that have weights that are significantly different from zero with a 95% confidence using the Z-test were subjected to BN analysis for pathway reconstruction.

3. Reconstruct Pathways Related to Cytotoxicity Using BN.

ICA identified the genes that have similar profiles to the LDH release profile. Based upon the expression level of these genes and the LDH profile, we applied BN analysis to determine how these genes are connected in a network and thus give rise to the LDH release or cytotoxicity. The resulting (full) network is available online at www.chems.msu.edu/groups/chan/fullnetwork.zip. To facilitate the analysis and experimental validation of the reconstructed network, we simplified the full network, which is illustrated in FIG. 1. We experimentally validated several of the connections inferred by the model. In addition, the model provided possible hypothesis as to the mechanism(s) involved in the palmitate-induced cytotoxicity.

3.1. Role of Stearoyl-CoA Desaturase (SCD) and Acetyl-CoA Carboxylase (ACC) in Palmitate Induced Cytotoxicity.

Stearoyl-CoA desaturase (SCD) was identified by the analysis to be closely associated with LDH release in the network. At the same time, acetyl-CoA carboxylase (ACC) was inferred to be connected to SCD. SCD is the rate-limiting enzyme to produce monounsaturated fatty acids. Its deficiency has been found to increase fatty acid oxidation by activating AMP-activated protein kinase (AMPK) in the liver [Dobrzyn et al. 2004]. AMPK phosphorylates ACC at Ser-79 which leads to the inhibition of ACC activity and decreased malonyl-CoA concentration. Malonyl-CoA inhibits carnitine palmitoyl-CoA transferase (CPT-1) [Kerner et al. 2000]. Thus a decreased level in malonyl-CoA activates CPT-1 activity and increases fatty acid beta-oxidation in the mitochondrion [Dobrzyn et al. 2004]. In the palmitate cultures, the gene expression level of SCD was reduced compared to the control. SCD endogenously produces unsaturated fatty acids, which have been found to protect the cells from palmitate-induced cytotoxicity in Chinese hamster ovary (CHO) cells [Listenberger et al. 2003].

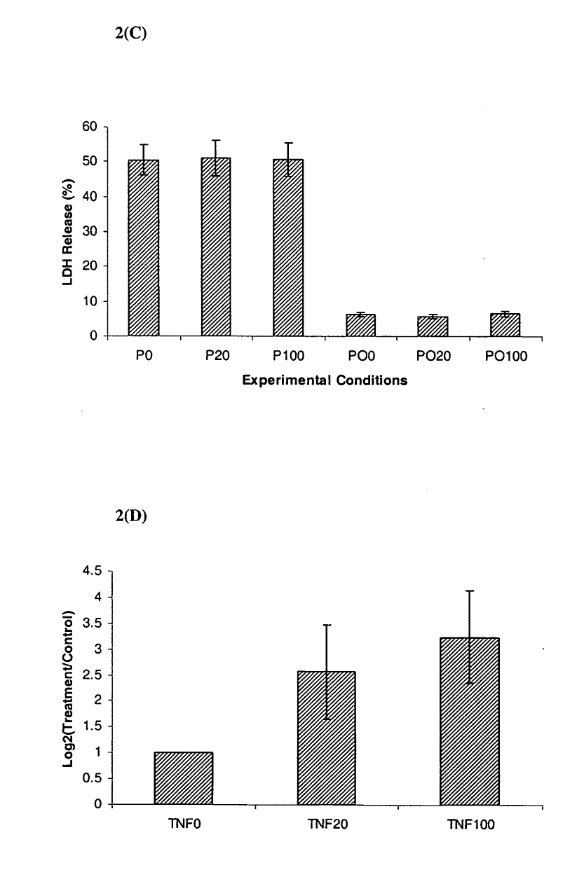

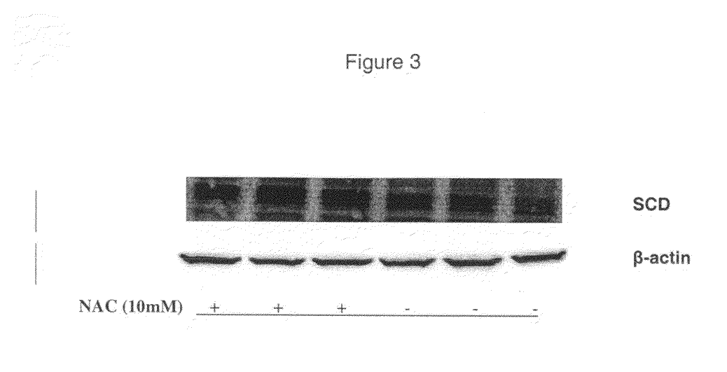

The protein expression level of SCD in HepG2 cells cultured in control (HepG2 medium), palmitate, oleate, palmitate+oleate, mediums were measured as a function of TNF-α with western blots. Palmitate supplementation decreased the protein expression level of SCD as compared to the control and oleate cultures. In addition, co-supplementing the palmitate cultures with oleate restored the SCD protein expression level (FIG. 2) and correspondingly reduced LDH release (FIG. 2C). Oxidative stress appears to be involved in down-regulating SCD in the palmitate cultures. Supplementing with 10 mM N-acetyl cysteine (NAC) prevented the SCD down-regulation (FIG. 3A) and reduced LDH release (FIG. 3B).

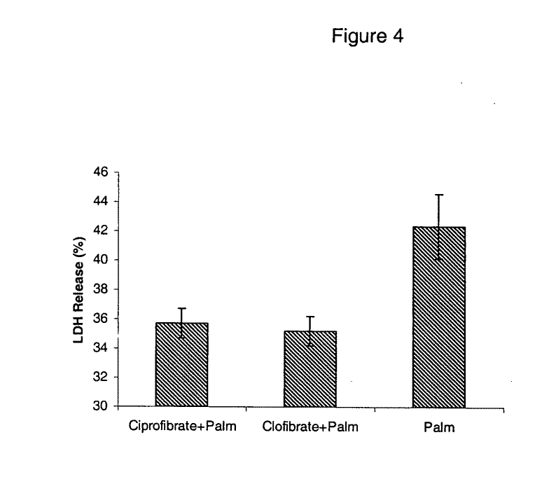

The involvement of SCD in palmitate induced cytotoxicity is supported by a recent study where over-expressing SCD was found to protect CHO cells from palmitate induced cytotoxicity [Listenberger et al. 2003]. In further support of the protective of role of SCD, 50 μM supplementation of clofibrate and ciprofibrate, which are known to increase the activity of SCD [Miller & Ntambi 1996], significantly decreased LDH release in the palmitate cultures (FIG. 4). Therefore, SCD was correctly identified by the model to be an important factor involved in modulating palmitate-induced cytotoxicity. In addition, TNF-α was also correctly predicted by the model to affect SCD (FIG. 2). The mechanism of TNF-α down-regulating SCD could be due to its repress of gene expression (Weiner et al. 1991). However gene expression of SCD was upregulated by TNF-α in HepG2 cells (FIG. 2D), which indicates SCD is not transcriptionally down-regulated of by TNF-α and translational and post-translational effects may be involved.

3.2 Activation of NF-κB by TNF-α is Mediated by PKC-δ

From FIG. 1 we find the connection between TNF-α and SCD is linked through NF-κB and PKC-δ, suggesting that PKC-δ is an intermediate factor in the activation of NF-κB. PKC-δ has been found to be a redox-sensitive kinase in many cell types [Kanthasamy et al. 2003]. PKC-δ is activated through translocation, tyrosine phosphorylation or proteolysis. During proteolysis, the native PKC-δ (72-74 kDa) is cleaved into two fragments, a catalytically active 41 kDa and a regulatory 38 kDa fragment. The 41 kDa catalytically active fragment plays a key role in promoting apoptotic cell death [Kanthasamy et al. 2003]. In addition, PKC-δ has been found to associate with the P60 TNF receptor during TNF-α triggered signaling [Kilpatrick et al. 2002]. NF-κB is an important cytoprotective transcription factor, which can be activated by oxidative stress and cytokines including TNF-α [Haddad 2002]. Inhibition of PKC-δ has been shown to attenuate TNF-α-mediated activation of the anti-apoptotic transcription factor NF-κB in adherent neutrophils [Kilpatrick et al. 2002). In our analysis, the model found that PKC-δ was regulated by the uncoupling protein (FIG. 1), which affects the intracellular ATP levels [Fleury et al. 1997], low ATP levels has been reported to inhibit the activation of PKC-δ tyrosine phosphorylation [Soltoff 2001]. Therefore, these results suggest that PKC-δ may be involved in the pathway of TNF-α activating NF-κB, in cells such as neutrophils [Kilpatrick et al. 2002] and pancreatic acinar cells [Satoh et al. 2004].

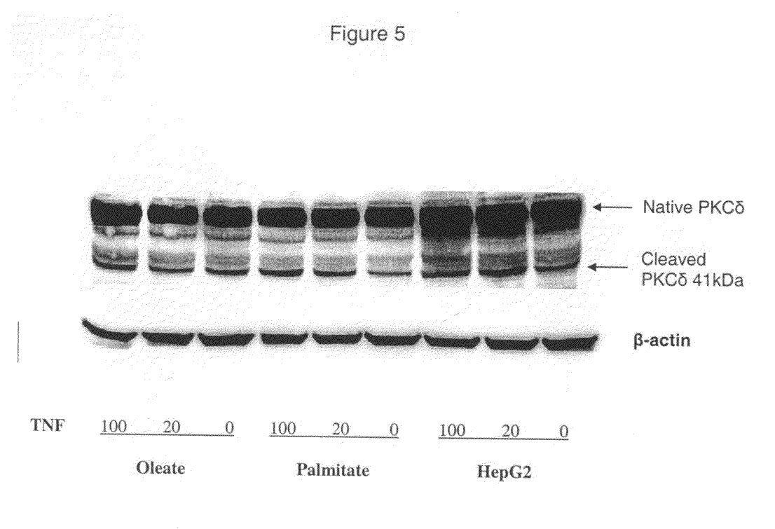

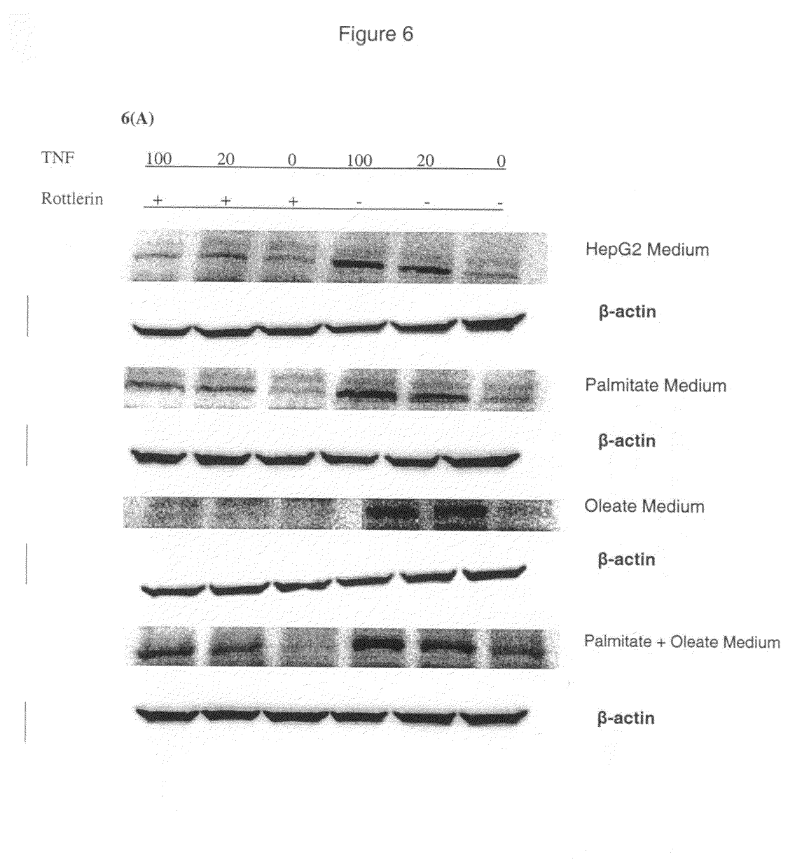

There has been no study to date that has indicated that PKC-δ mediates TNF-α's activation of NF-κB in HepG2 cells. Therefore, we tested the possibility of this link in HepG2 cells by adding rottlerin, an inhibitor of PKC-δ, and measuring the protein expression and activity levels of NF-κB with western blots. As shown in FIG. 5, TNF-α increased the expression of PKC-δ 41 kDa catalytic active fragment. This confirmed the connection between TNF-α and PKC-δ in the reconstructed network (model). To determine whether PKC-δ is involved in mediating the activation of NF-κB by TNF-α, PKC-δ was inhibited by a PKC-δ specific inhibitor rottlerin. The activity of NF-κB was measured with western blots by detecting the levels of phosphorylated NF-κB p65 at serine 536 [Sakurai et al. 2003]. As shown in FIG. 6(A), the activation of NF-κB p65 was attenuated by rottlerin. Moreover, as shown in FIG. 6(B) rottlerin supplementation increased LDH release in the palmitate cultures, suggesting the cytoprotective role of NF-κB is mediated in part by PKC-δ. Therefore, PKC-δ was appropriately identified by the model to be an important factor in mediating the TNF-α signaling pathway.

3.3 Involvement of Bcl-2, eIF2B, PP2A, PKR in LDH Release

The analysis also found connections between TNF, TOM20, B cell leukemia (Bcl-2) and glutamate cysteine ligase (GCL). Bcl-2 family of proteins control mitochondria membrane permeability. Targeting of the Bcl-2 protein to the mitochondria is mediated by the interaction between the C terminus of Bcl-2 and the translocase of outer membrane (TOM20). TOM20 is an important protein importing receptor located at the mitochondrial outer membrane [Motz et al. 2002]. An increase in the permeability of the outer mitochondria membrane is central to apoptosis, since it leads to the release of apoptotic factors such as cytochrome c into the cytoplasm and induces apoptosis. GCL is the rate-limiting enzyme in producing glutathione, which is important in maintaining cellular redox balance [Droge et al. 1994]. Inhibiting GCL in fATIII cells has been found to enhance Bax and P53 expression over Bcl-2 [Haddad 2004]. Therefore, the model identified a possible connection between Bcl-2 and GCL that has been verified in other cells.

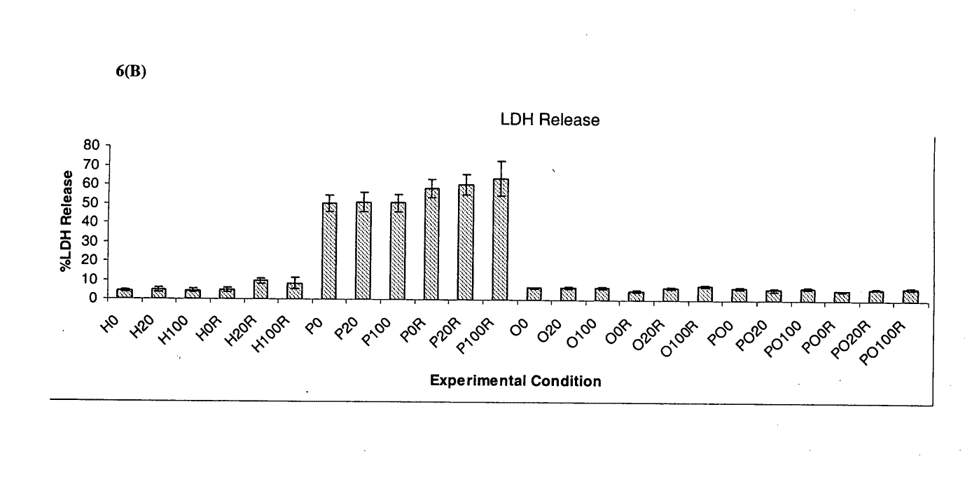

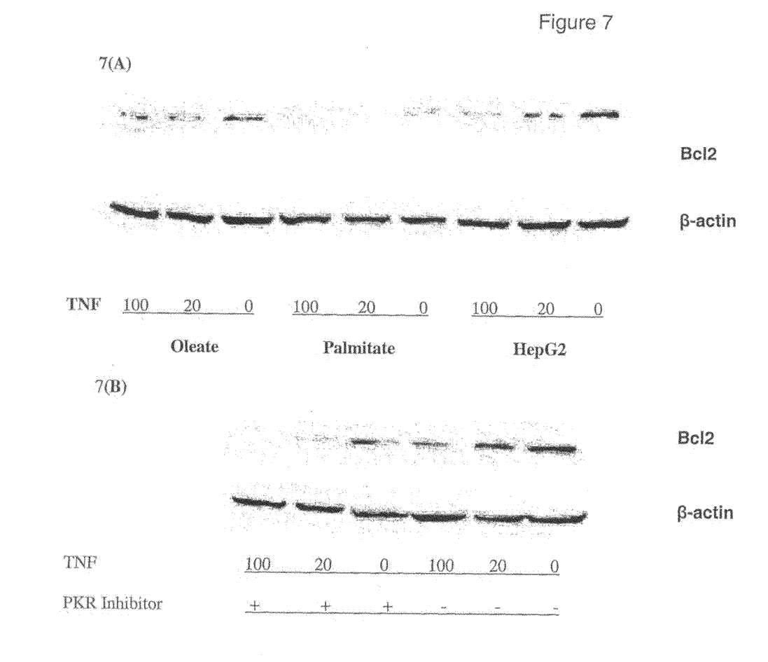

The regulation of Bcl-2 by TNF-α is cell dependent, e.g., Bcl-2 was suppressed in FaO rat hepatoma cells [Kim et al. 2002] while it was induced in rat hippocampal neuron cells [Tamatani et al. 1999]. The protein expression level of Bcl-2 in cultured HepG2 cells as a function of TNF-α concentrations were measured with western blots (FIG. 7A). In the HepG2 cells, TNF-α at 20-100 ng/mL suppressed the protein expression level of Bcl-2 and palmitate culture decreased Bcl-2 expression compared to control and oleate cultures. In addition, PKR was also found in model to be related to Bcl-2. PKR inhibitor (6 μM) supplementation to the culture medium of control decreased the Bcl-2 expression (FIG. 7B), correspondingly LDH release increased from 3% to 25%. Therefore, the model appropriately identified Bcl-2 to be an important factor regulating LDH release and Bcl-2 was regulated by TNF-α, which was attenuated by PKR inhibitor leading to increased LDH release.

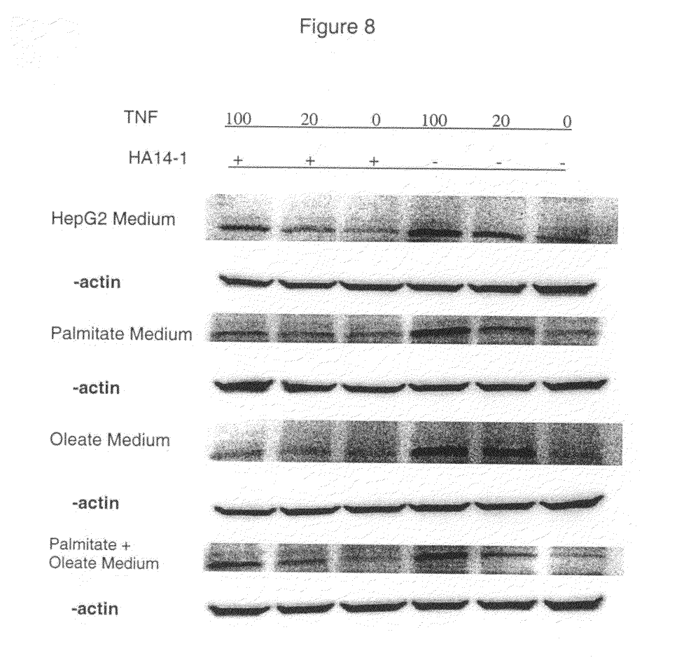

The regulation of NF-κB by Bcl-2 is cell specific, e.g., over expression of Bcl-2 increased the activity of NF-κB in PC 12 cells [Jang & Surh 2004] while Bcl-2 down regulated the activation of NF-κB in Hela and NIH-3T3 cells [Massaad et al. 2004]. Bcl-2 was inhibited with HA14-1 to study the role of Bcl-2 in the activation of NF-κB by TNF-α in HepG2 cells. As shown in FIG. 8, inhibiting Bcl-2 attenuated the activation of NF-κB.

In the reconstructed network from the gene expression data, Bcl-2, eIF2B, PP2A, PKR were connected with two apoptosis related genes, apoptotic chromatin condensation inducer and apoptosis inhibitor, suggesting that these four factors are likely involved in the apoptotic signaling pathway. The double stranded RNA-dependent protein kinase (PKR) is a serine-threonine kinase consisting of two domains: an amino-terminal regulatory domain and a carboxyl-terminal catalytic domain. PKR can be cleaved by caspase-3, 7, 8 to liberate the eIF2-α kinase domain, which phosphorylates eIF2-α [Saelens et al. 2001]. In order for eIF2-α to initiate translation, it has to form a complex with methionyl initiator tRNA and GTP. This complex is essential for recruiting Met-tRNAᵢ^{Met} to the 40S ribosomal subunit and initiating mRNA translation. After delivery of Met-tRNAᵢ^{Met}, eIF2-bound GTP is hydrolyzed to GDP.

To continue translation the eIF2-bound GDP must be exchanged for GTP. This exchange is catalyzed by eIF2B. Phosphorylation of the alpha subunit of eIF-2 stabilizes the eIF2-GDP-eIF2B complex, thus inhibiting the release of eIF2B. Because eIF2B is obligatory for the exchange of GTP for eIF-2 bound GDP and exists in the cell at relatively low concentrations with respect to eIF-2, the exchange easily can be inhibited when only a fraction of the eIF2-α is phosphorylated [Saelens et al. 2001]. Thus, phosphorylation of eIF2-α by PKR will inhibit protein synthesis and lead to apoptosis [Saelens et al.

2001].

PKR binds to PP2A at the B56 alpha regulatory subunit and increases the phosphatase activity of PP2A [Xu et al. 2000]. PP2A is a major Ser/Thr phosphatase involved in many signal transduction pathways. PP2A can dephosphorylate and inactivate the anti-apoptotic Bcl-2 at Ser⁷⁰ [Deng 1998]. Bcl-2 inhibits apoptosis by guarding the mitochondrial gate against the release of cytochrome c and the subsequent activation of caspases. Therefore, PKR and in turn PP2A could promote apoptosis by inactivating Bcl-2 through dephosphorylation.

4. Simulating Genetic Perturbation with BN Classifier.

Based upon the network learned from the gene expression data shown in FIG. 4, a BN classifier was constructed to predict LDH release from the gene expression. Genetic perturbation of SCD, Bcl-2, PKC-δ was simulated with the BN classifier to study their effects on the probability of LDH release taking different levels (Table 1).

TABLE 1
Simulating genetic perturbation and its effects on LDH release

| | | Probability of LDH Release | | | |
|---|---|---|---|---|---|
| | | Control | | Palmitate | |
| Gene | Perturbation | Low | High | Low | High |
| — | No perturbation | 0.94 | 0.06 | 0.02 | 0.98 |
| SCD | Upregulation | 0.94 | 0.06 | 0.45 | 0.55 |
| | Downregulation | 0.9 | 0.1 | 0.02 | 0.98 |
| Bcl-2 | Upregulation | 0.94 | 0.06 | 0.17 | 0.83 |
| PKC-delta | Downregulation | 0.9 | 0.1 | 0.02 | 0.98 |

The probability of LDH release at high or low level in control and palmitate cultures was shown in the table when gene no perturbation, up/down regulation of SCD, upregulation of Bcl-2, down-regulation of PKC-delta were simulated with the BN classifier using the structure shown in FIG. 4.

Once the network is reconstructed from the gene expression data by TIPS, one could evaluate the effect of perturbing one or several genes (nodes) on any other gene (node) in the network, as well as on LDH release itself. Thus far, we have only simulated the effect of single gene perturbations on LDH release. Genetic perturbations of SCD, Bcl-2, and PKC-δ were simulated with a BN classifier to study the effect of perturbing these genes (nodes) on the probability of LDH taking on either a high or low release phenotype (see Table 1). Over-expression or silencing of SCD was simulated by setting the SCD expression level at either a high or low level, respectively. Upregulating SCD in the palmitate cultures reduced the probability from ˜98% to ˜45% that the LDH release would remain high. While downregulating SCD in the control cultures suggests that the LDH release would likely remain low (e.g., downregulating SCD will have no effect on LDH release).

The simulation results agree well with the literature and our experimental observations. Over-expressing SCD has been shown to prevent palmitate-induced cytotoxicity [Listenberger et al. 2003] and activating SCD with clofibrate or ciprofibrate significantly decreased LDH release (FIG. 4). Silencing of SCD in control by TNF-α (FIG. 2) did not affect LDH release (FIG. 6B). Similarly, we also used the reconstructed network to simulate Bcl-2 up-regulation and PKC-δ down-regulation. The model suggests that upregulating Bcl-2 would slightly lower the probability that LDH would take on a high release phenotype, as compared with the unperturbed state. Indeed, we found that silencing Bcl-2 did not alter the level of LDH release.

The model suggests that downregulating PKC-δ will not lower the likelihood of a high LDH release, which was confirmed by experiments. We found that inhibiting PKC-δ with rottlerin did not reduce LDH release, rather rottlerin increased LDH release in the palmitate cultures by up to 25%. Through the BN framework, we can assess the role of each gene (node) on LDH release by perturbing the reconstructed network artificially and determining how the probability of LDH, taking on either a high or low release phenotype, changes. The reconstructed network can help identify which nodes have the most impact on LDH release and thus should be evaluated further with experiments. The BN framework allowed us to perturb the network artificially to identify the sensitive nodes for functional modulation.

### Discussion

With the high dimensional biological data available to characterize a cellular state, it is a challenge to develop robust approaches to integrate various orthogonal datasets to identify genes and pathways that induce a phenotype. Metabolite profiles were used in this paper to characterize the cellular phenotype. Currently, only one metabolic profile of LDH release was used to identify the active gene regulatory network that was perturbed by TNF-α and FFA exposure. The phenotype characterization at the metabolic level can be improved by incorporating more metabolic functions e.g. glycolysis, TCA cycle, fatty acid metabolism. In this way, the causal effects can be checked hierarchically at both metabolic and genetic levels. An alternative approach is to extract a few latent variables from metabolic profiles to represent the major pathways with approaches such as ICA and PLS [Griffin et al. 2004]. To test the robustness of the framework, 10% noise were added to the data. The noise perturbed network was shown in FIG. 11. Compared to the network before noise perturbation, LDH release was still predicted to be closely related to the factors such as SCD, PKC-δ et al. discussed in this paper, although some of the connections were missing. Therefore, the framework is robust to a certain degree of noise in the data.

Gene expression and LDH profiles were integrated in this paper to identify pathways involved in palmitate-induced cytotoxicity in HepG2 cells. The framework provided new hypothesis to test for further elucidation of the underlying mechanism involved in cytotoxicity. The significance of the proposed framework is its ability to extract the relevant information from the high dimensional gene expression data. The metabolic profile directed the information extraction process. Proteins relay the information from genes to execute biological functions which determine the cell phenotypes e.g. metabolic functions. Thus the effects of regulations occurring at protein level could ultimately lump into profiles of phenotype. As illustrated in this paper, it is possible to uncover the regulating information of the intermediate protein level by integrating phenotype and gene expression data. A next logical step is to feed the new experimental information back to the model. In addition, experimental approaches such as ChlP technology measure the physiological interactions between genes and proteins. It can be foreseen that the interaction data will become more available in the near future. Together with the interaction data, the experimental information needs to be integrated to the gene expression data in models e.g. BN to improve the network inferred from the gene expression data. One way to accomplish the integration is to define the a priori probabilities of the connections in the gene regulatory network based upon the information. (Hartemink et al. 2002] provided an example of combining protein-DNA interaction data to gene expression in a BN framework to infer regulatory network underlying pheromone response in yeast.

Due to computational limitation it is not possible to reconstruct network for all genes. GA/PLS and ICA provide an approach to select relevant genes for further study. However some useful information could be skipped due to the noise in the data. For example, NF-κB genes were not selected by GA/PLS and ICA. However, the algorithm selected TNF-α related genes and in addition NF-κB was found changed with TNF-α in our previous experiment. Therefore, we put the gene of NF-κB back for further BN analysis and the resulting network indicated the connection between TNF-α and NF-κB and also the involvement of PKC-δ. Thus, supervised gene selection should be coupled with the unsupervised gene selection by GA/PLS and ICA. The supervision could be automated by defining weights of genes in the GA/PLS learning [Li & Chan 2004a]. For example, if one knows that some genes are related and others are not related to a metabolic function, this information can be incorporated into the fitness function by adding a factor that awards the inclusion of relevant genes and punishes the inclusion of irrelevant genes. Each gene is assigned a score based upon its relevance to the metabolic function based upon the literature. An overall gene relevance score (Gs in the equation below) can be obtained by summing up the score of each individual gene and integrating it into a fitness function as follows:

$$fitness = \frac{1}{\sum {( {y}_{i} - {\hat{y}}_{i} )}^{2} + {LV}^{w 1}} + {Gs}^{w 2}$$

In conclusion, this paper proposed a framework to integrate gene expression and metabolic profiles to identify regulatory pathways underlying palmitate induced cytotoxicity in HepG2 cells. The framework was able to generate biologically testable hypothesis by identifying the important factors such as PKC-δ and Bcl-2 and their roles in regulating cytotoxicity in HepG2 cells.

### Material and Methods

### Materials

Cell Culture. 1 million Hep G2/C3A cells (ATCC, Manassas, Va.) were seeded into each well of 6-well culture plate. The cells were kept in 2 mL of medium containing Dulbecco's modified Eagles medium (Invitrogen, Carlsbad, Calif.) supplemented with 10% fetal bovine serum (ATCC) and 2% Penicillin-streptomycin (Invitrogen). Cells were incubated at 37° C. and in 10% CO₂ atmosphere. After cells reached confluence, the medium was replaced with 2 mL of treatment of FFA including palmitate (700 μM), oleate (700 μM), linoleate (700 μM) and TNF-α (0, 20, 100 ng/mL′)

Cytotoxicity measurement. For the LDH measurements, cells were cultured in different media for 24 h and the supernatant was collected. Cells were washed with phosphate buffered saline (PBS) and kept in 1% Triton-X-100 in PBS for 24 h at 37° C. Cell lysate was then collected, vortexed for 15 seconds, and centrifuged at 7000 rpm for 5 minutes. Cytotoxicity detection kit (Roche Applied Science, Indianapolis, Ind.) was used to measure the LDH release. LDH released was normalized to the total LDH (released+lyzed).

Gene expression profiling. Cells were cultured in 10 cm tissue culture plates until confluence and then exposed to different treatments. RNA was isolated with Trizol reagent. The gene expression profiling was obtained with cDNA microarray. Analyses were done at the Van Andel Institute, Grand Rapids, Mich. The protocols are available online at (http://microarray.vai.org/protocols/). There were two biological replicates for each condition and each replicate was measured with the Cy3 and Cy5 dyes.

PKC-δ Inhibiting Analysis. The levels of PKC-δ in HepG2, palmitate (700 μM), oleate (700 μM) and palmitate (400 μM)+oleate medium (300 μM) with TNF-α supplementation of 0, 20, 100 ng/mL were detected with western blotting using anti-PKC-δ antibody (Santa Cruz Biotechnology, Inc., Santa Cruz, Calif., US) at 1:2000 dilution.

PKC-δ was inhibited with rottlerin (BIOMOL Research Laboratories, Plymouth Meeting, Pa.). 1 μM Rottlerin was added to cell culture in HepG2 medium, palmitate medium, oleate medium, and palmitate (400 μM)+oleate medium (300 μM). After 48 hours of exposure, cells were lysated with 1× SDS sample buffer. After ultrasonication for 11-15 seconds, the suspension was centrifuged (10,000 relative centrifugal force (rcf), 5 minutes). The supernatant was run on 7.5% gradient SDS-PAGE, transferred to a nitrocellulose membrane, blocked for 1 hour at room temperature with 5% milk protein solution in Tris buffered saline with Tween 20, and exposed to monoclonal anti-phospho NF-κB (65 kDa subunit) (Cell Signaling Technology Inc., MA) at 1:2000 dilution overnight at 4° C. The blot was washed and put in rabbit anti-mouse IgG secondary antibody (1:2000 dilution in TBS-Tween) for 1 hour. The blot was washed thrice each in TBS-Tween and TBS and developed using Supersignal West Femto Substrate (Pierce Chemicals), and imaged with Bio-Rad imager.

Bcl-2 Inhibiting Analysis. Cells cultured in mediums of HepG2, Palmitate, Oleate, Palmitate (400 μM)+Oleate medium (300 μM) were lysated as described before. The protein samples were run on 10-20% gradient SDS-PAGE. Bcl-2 was probed with Bcl-2 antibody (1:1000) (Cell Signaling Technology, Inc., Danvers, Mass., US) as the primary antibody and goat anti-rabbit IgG as the second antibody at 1:1000 dilution.

Bcl-2 was inhibited with HA14-1 (BIOMOL Research Laboratories, Plymouth Meeting, Pa.) at 10 μM. The phospho-NF-κB p65 was detected with monoclonal anti-phospho NF-κB (65 kDa subunit) (Cell Signaling Technology Inc., Danvers, Mass., US) at 1:2000 dilution.

ANOVA test. The analysis of variance (ANOVA) was applied to compare the effect of treatment (e.g. FFA, TNF-α) and to determine whether a treatment has a significant effect. We applied a two-way ANOVA test to identify the genes that are affected by FFA or TNF-α or the interaction between FFA and TNF-α. The significance level was set to P≦0.01. The analysis was performed in MATLAB 6.3 using Stats Toolbox.

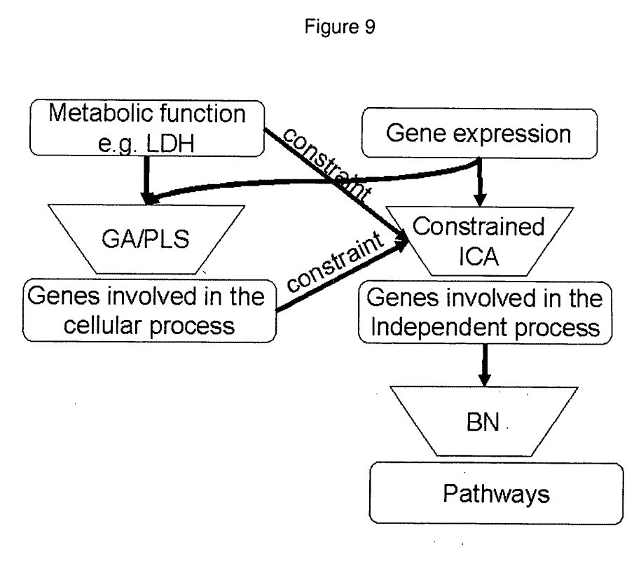

A framework to integrate gene expression and metabolic profile. We apply a mathematical framework that first integrates genetic algorithm (GA) and partial least squares (PLS) analyses to identify the genes relevant to a particular cellular function such as LDH release, but these genes may be involved in many independent pathways. Thus the framework then applies ICA to identify the independent pathways, i.e. the genes involved in LDH release. Finally the connections between these genes selected by ICA are reconstructed using BN Analysis to uncover how the genes interact with each other in the independent pathways. The reconstructed network illustrates how the genes interact under the given environmental conditions to regulate LDH release. The framework was shown schematically in FIG. 9.

1. Genetic algorithm/partial least square analysis (GA/PLS). Based upon the notion that metabolic functions are regulated in part by the enzymes catalyzing the reactions, which in turn are determined partly by their gene expression levels, we assume that the metabolic function can be predicted from the expression level of a subset of genes that are involved with the metabolic function. We approximate the relation between the metabolic function and expression level of this subset of genes with a log-linear model:

$$\frac{Met ( treatment )}{Met ( control )} = {\prod }_{i = 1}^{n} ( \frac{{Gene ( treatment )}_{i}}{{Gene ( control )}_{i}} ) C ( i ) \qquad ( 1 )$$

where Met(treatment) and Met(control) are the metabolic function for the treated and control cultures, respectively; Gene(treatment)ᵢ and Gene(control)ᵢ are the expression level of gene i for the treated and control cultures, respectively. Denoting Y as

$${log}_{2} ( \frac{Met ( treatment )}{Met ( control )} )$$

### and Xᵢ as

$${log}_{2} ( \frac{{Gene ( treatment )}_{i}}{{Gene ( control )}_{i}} ) ,$$

equation (1) is transformed to:

$$Y = {\sum }_{i = 1}^{n} C ( i ) {X}_{i} \qquad ( 2 )$$

C(i) are regression coefficients calculated from equation (2) above.

Since DNA microarray data are typically measured with respect to a reference level, we applied a log-linear model, which works well when data are presented as relative levels. Furthermore, a log-linear model allows some of the nonlinear relationships between metabolic function and gene expression to be captured. Log-linear Models have been applied to approximate nonlinear processes in biochemical systems [Ni & Savageau 1996a; Ni & Savageau 1996b]. In this study the coefficients C(i) in equation (2) are determined by PLS analysis and the genes, Gene;, are selected by GA/PLS as described below.

We developed a GA/PLS model to identify genes involved in regulating hepatocellular functions, such as urea production and intracellular triglyceride accumulation [Li & Chan 2004a]. Similarly, in this investigation we applied GA/PLS to identify the genes involved in LDH release, an indicator of cytotoxicity. For details on GA/PLS see [Li & Chan 2004a].

In order to select an optimal subset of genes (X) to predict a metabolic function (Y). Genetic algorithm (GA) was used to select a subset of genes that provides minimal error between the measured and predicted level of the metabolic function (Y). GA is an optimization method based upon the theory of natural selection. GA begins with an initial, randomly selected population. Each ‘individual’ in the population represents a set of selected genes plus the number of PLS latent variables. An ‘individual’ is denoted by a string:

gᵢ,g₂, . . . ,g₃₀₁,g₃₀₂,g₃₀₃, . . . ,g₈₃₀,LV

where gᵢ i=1,2, . . . ,303, . . . 830, contains binary data with values of 1 (gene selected) or 0 (gene not selected); LV is the number of latent variables in the

PLS model. Each ‘individual’ is a potential solution to the optimization problem and the “fitness” of the selected gene is evaluated by a fitness function defined as follows

$$fitness = \frac{1}{\sum {( {y}_{i} - {\hat{y}}_{i} )}^{2} + {LV}^{w}} \qquad ( 3 )$$

where yᵢ is the measured level of the metabolic function, ŷᵢ is the PLS prediction of the level of the metabolic function, LV is the number of latent variables in the PLS model, and w is a weighting factor to establish an optimal balance between prediction accuracy and the model size (number of latent variables in the PLS model).

The whole dataset is separated into three different groups, namely a training, monitoring, and testing data-sets, in order to avoid over-fitting. First, GA randomly selects a subset of genes from the training data-set. The expression levels of these genes are subsequently used to construct a PLS model to predict LDH release. The accuracy of the level of LDH release predicted by the PLS model is evaluated with equation (3) using both the training and monitoring datasets. The accuracy of the PLS model prediction is used to assess the fitness of the subset of genes selected. Since GA cannot guarantee the global optima, GA/PLS was run multiple times and the frequency with which each gene was selected by the algorithm was counted. The genes with high frequency were selected into the final relevant gene subset, based upon which the prediction model was constructed. The test data-set was then used to validate the predictive capability of the final GA/PLS model.

2. Independent Component Analysis. ICA is a statistical method that has been applied to reveal “hidden factors” underlying sets of signal measurements [Liebermeister 2002]. For example, two individuals are speaking simultaneously in a room. The signals consisting of a mixture of these two voices are recorded by ten recorders at different locations in the room. Given these ten different signals, ICA is able to discern the original voice of the two speakers, and thus these two voices are the “hidden factors” underlying the recorded or observed signals. By analogy, the expression levels of the genes are the recorded signals which are affected by underlying regulatory pathways. We denote the signal measurements Y to be the gene expression data, S to be the independent components (pathways), and A to be the mixing matrix. The ICA model can be expressed as

Y=A S (4)

The gene expression Y is supplied to the ICA model [Lin et al. 2002] and the mixing matrix A can be uniquely estimated by assuming that the components in S are statistically independent to each other. Y(i,t) represents the expression of gene i in experiment t, A(i,j) represents weight of gene i in independent pathway j, S(j,t) represents the profile of independent pathway j in experiment t. Since the objective here is to identify LDH release-related independent pathway, A was further constrained with the frequency learned by GA/PLS and S was further constrained with LDH release profile. Let F(i) be the frequency of gene i with respect to LDH release and a(i) be the weight of gene i in the pathway related to LDH release. Thus, a is constrained to have a correlation with F by equation (5), where p1 is a threshold value.

Corr1=a^{T}*diag(F)*a/(a^{T}*a)>p1 (5)

Let s(t) be the profile of LDH related pathway in experiment t and L(t) be the profile of LDH release in experiment t. Similarly, s is constrained to have a correlation with L by equation (6), where p2 is a threshold value.

Corr2=s^{T}*L*L^{T}*s/(s*s^{T})>p2 (6)

The constrained ICA decomposition [Lin et al. 2002] is schematically shown in FIG. 10. In this process, matrix Y is decomposed into A and S, subjected to constraints of (5) and (6) by minimizing the mutual information between the independent components. Each row in S represents profile of one independent component.

3. Bayesian Networks. Bayesian networks are directed acyclic graphs (DAG) whose nodes correspond to variables and whose arcs represent the dependencies between variables. The dependencies are determined by the conditional probabilities of each node xᵢ, given its parent node pₐ, Pr(xᵢ|pₐ(xᵢ)). A Bayesian network i) assumes conditional independence, such that each node is independent to its non-descendants, given it parents, in other words, B and C are conditionally independent to each other given A (see FIG. 11), then

Pr(B|C,A)=Pr(B|A) (7)

and ii) consists of the joint distribution defined by a set of variables {xᵢ} as:

$$Pr ( {x}_{1} , … , {x}_{n} ) = {\prod }_{i = 1}^{N} Pr ( {x}_{i} \vert {p}_{a} ( {x}_{i} ) ) \qquad ( 8 )$$

In the example above:

Pr(A, B, C, D)=Pr(A)Pr(B|A)Pr(C|A)Pr(D|B) (9)

In the current investigation we applied an information theory based constraint method to infer the structure of the gene regulatory network through a three-step algorithm [Li & Chan 2004b]. First, mutual information between each pair of genes are calculated and those genes with mutual information greater than a threshold value were connected. The mutual information I(Xᵢ,Xⱼ) for each pair of genes (x₆xⱼ) is computed as:

$$I ( {X}_{i} , {X}_{j} ) = {\sum }_{{x}_{i} , {x}_{j}} Pr ( {x}_{i} , {x}_{j} ) log \frac{Pr ( {x}_{i} , {x}_{j} )}{Pr ( {x}_{i} ) P ( {x}_{j} )} .$$

In step 2, arcs are added to genes that are not independent to each other as determined by conditional independency test [Li & Chan 2004b]. The conditional independency test is based on conditional mutual information as defined by the equation below. For I(Xᵢ,Xᵢ|c) less than the specified threshold value, (Xᵢ,Xⱼ) are said to be independent given c, where c is a set of genes

$$I ( {X}_{i} , {X}_{j} \vert c ) = {\sum }_{{x}_{i} , {x}_{j} , c} Pr ( {x}_{i} , {x}_{j} , c ) log \frac{Pr ( {x}_{i} , {x}_{j} \vert c )}{Pr ( {x}_{i} \vert c ) P ( {x}_{j} \vert c )} .$$

Finally, arcs are removed if two genes are independent to each other as determined by conditional independency test.

### REFERENCES

Akutsu T, Miyano S, Kuhara S, Identification of genetic networks from a small number of gene expression patterns under the Boolean network model, Pacific Symposium on Biocomputing 4:17-28 (1999).
Deng X, Ito T, Carr B, Mumby M, May Jr W S, Reversible phosphorylation of Bcl2 following interleukin 3 or bryostatin 1 is mediated by direct interaction with protein phosphatase 2A, J. Biol. Chem. 273(51):34157-34163 (1998).
Dobrzyn P, Dobrzyn A, Miyazaki M, Cohen P, Asilmaz E, Hardie D G, Friedman J M, Ntambi J M, Stearoyl-CoA desaturase 1 deficiency increases fatty acid oxidation by activating AMP-activated protein kinase in liver, Proc. Nat'l Acad. Sci, (USA) 101(17):6409-6414 (2004).
Droge W, Schulze-Osthoff K, Mihm S, Gaiter D, Schenk H, Eck H P, Roth S, Gmunder H, Functions of glutathione and glutathione disulfide in immunology and immunopathology, FASEB J. 8(14):1131-1138 (November 1994).
Eisen M B, Spellman P T, Brown P O, Botstein D, Cluster analysis and display of genome-wide expression patterns, Proc. Nat'l Acad. Sci. (USA) 95(25):14863-14868 (Dec. 8, 1998).
Friedman N, Inferring cellular networks using probabilistic graphical models, Science 303(5659):799-805 (2004).
Fleury C, Neverova M, Collins S, Raimbault S, Champigny O, Levi-Meyrueis C, Bouillaud F, Seldin M F, Surwit R S, Ricquier D, Warden C H, Uncoupling protein-2: a novel gene linked to obesity and hyperinsulinemia, Nat. Genet. 15(3):269-72 (March 1997).
Griffin J L, Bonney S A, Mann C, Hebbachi A M, Gibbons G F, Nicholson J K, Shoulders C C, Scott J, An integrated reverse functional genomic and metabolic approach to understanding orotic acid-induced fatty liver, Physiol. Genomics 17(2):140-149 (2004)
Haddad J J, Science review: Redox and oxygen-sensitive transcription factors in the regulation of oxidant-mediated lung injury: role for nuclear factor-kappaB, Crit. Care. 6(6):481-490 (December 2002; Epub. Oct. 14, 2002)
Haddad J J, On the antioxidant mechanisms of Bcl-2: a retrospective of NF-κB signaling and oxidative stress, Biochem. & Biophys. Res. Comm. 322(2):355 (2004).
Hartemink A J, Gifford D K, Jaakkola T S, Young R A, Combining location and expression data for principled discovery of genetic regulatory network models, Pacific Symposium on Biocomputing 7:437-449 (2002) (http://helix-web.stanford.edu/psb02/hartemink.pdf)
Ideker T, Ozier O, Schwikowski B, Siegel A F, Discovering regulatory and signalling circuits in molecular interaction networks. Bioinformatics 18 Suppl 1:S233-S240 (July 2002) (doi:10.1093/bioinformatics/18.suppl_{—}1.S233).
Jang J-H, Surh Y-J, Bcl-2 Attenuation of oxidative cell death is associated with up-regulation of γ-glutamylcysteine ligase via constitutive NF-κB activation, J. Biol. Chem. 279(37):38779-38786 (2004).
Kanthasamy A G, Kitazawa M, Kanthasamy A, Anantharam V, Role of proteolytic activation of protein kinase C delta in oxidative stress-induced apoptosis, Antioxid. & Redox Signal. 5(5):609-620 (October 2003).
Kerner J, Hoppel C, Fatty acid import into mitochondria, Biochim. Biophys. Acta 1486(1):1-17 (Jun. 26, 2000).
Kilpatrick L E, Lee J Y, Haines K M, Campbell D E, Sullivan K E, Korchak H M, A role for PKC-delta and PI 3-kinase in TNF-alpha-mediated antiapoptotic signaling in the human neutrophil, Am. J. Physiol. Cell Physiol. 283(1):C48-57 (July 2002).
Kim B-C, Kim H-T, Mamura M, Ambudkar I S, Choi K-S, Kim S-J, Tumor necrosis factor induces apoptosis in hepatoma cells by increasing Ca²⁺ release from the endoplasmic reticulum and suppressing Bcl-2 expression, J. Biol. Chem. 277(35):31381-31389 (2002).
Kitazawa M, Anantharam V, Yang Y, Hirata Y, Kanthasamy A, Kanthasamy A G, Activation of protein kinase Cδ by proteolytic cleavage contributes to manganese-induced apoptosis in dopaminergic cells: protective role of Bcl-2, Biochem. Pharmacol. 69(1):133-146 (Jan. 1, 2005).
Lee T I, Rinaldi N J, Robert F, Odom D T, Bar-Joseph Z, Gerber G K, Hannett N M, Harbison C T, Thompson C M, Simon I, et al., Transcriptional regulatory networks in Saccharomyces cerevisiae, Science 298(5594):799-804 (Oct. 25, 2002).
Li Z, Chan C, Integrating gene expression and metabolic profiles, J. Biol. Chem. 279(26):27124-27137 (Jun. 24, 2004a; Epub. Apr. 23, 2004a).
Li Z, Chan C, Inferring pathways and networks with a Bayesian framework, FASEB J. 18(6):746-748 (April 2004b; Epub. Feb. 6, 2004b)
Li Z, Chan C, Extracting novel information from gene expression data, TRENDS in Biotechnology 22(8):381-83 (August 2004c).
Liebermeister W, Linear modes of gene expression determined by independent component analysis, Bioinformatics 18(1):51-60 (2002).
Lin S M, Liao X, McConnell P, Vata K, Carin L, Goldschmidt P, Using functional genomic units to corroborate user experiments with the Rosetta compendium, in S M Lin & K F Johnson (eds.), Methods of Microarray Data Analysis II: Papers from CAMDA '01, pp. 123-137 (2002) (http://www.ee.duke.edu/˜xjliao/paper/BookChapter02_draft_DNA_microarray.pdf) (Critical Assessment of Microarray Data Analysis 2001, held Oct. 15-16, 2001 at Duke University, Durham, N.C., US).
Listenberger L L, Han X, Lewis S E, Cases S, Farese R V, Jr., Ory D S, Schaffer J E, Triglyceride accumulation protects against fatty acid-induced lipotoxicity, Proc. Nat'l Acad. Sci (USA) 100(6):3077-3082 (2003).
Massaad C A, Portier B P, Taglialatela G, Inhibition of transcription factor activity by nuclear compartment-associated Bcl-2, J. Biol. Chem. 279(52):54470-54478 (2004).
Miller C W, Ntambi J M, Peroxisome proliferators induce mouse liver stearoyl-CoA desaturase 1 gene expression, Proc. Nat'l Acad. Sci. (USA) 93(18):9443-8 (Sep. 3, 1996).
Motz C, Martin H, Krimmer T, Rassow J, Bcl-2 and porin follow different pathways of TOM-dependent insertion into the mitochondrial outer membrane, J. Molec. Biol. 323(4):729-738 (2002).
Ni T C, Savageau M A, Application of biochemical systems theory to metabolism in human red blood cells: Signal propagation and accuracy of representation, J. Biol. Chem. 271(14):7927-7941 (Apr. 5, 1996a).
Ni T C, Savageau M A, Model assessment and refinement using strategies from biochemical systems theory: application to metabolism in human red blood cells, J. Theoretical Biology 179(4):329-368 (Apr. 21, 1996b).
Saelens X, Kalai M, Vandenabeele P, Translation inhibition in apoptosis: caspase-dependent PKR activation and eIF2-alpha phosphorylation, J. Biol. Chem. 276(45):41620-41628. (Nov. 9, 2001; Epub Sep. 12, 2001).
Sakurai H, Suzuki S, Kawasaki N, Nakano H, Okazaki T, Chino A, Doi T, Saiki I, Tumor necrosis factor-α-induced IKK phosphorylation of NF-κB p65 on serine 536 Is mediated through the TRAF2, TRAF5, and TAK1 signaling pathway, J. Biol. Chem. 278(38):36916-36923 (2003).,
Satoh A, Gukovskaya A S, Nieto J M, Cheng J H, Gukovsky I, Reeve J R Jr, Shimosegawa T, Pandol S J, PKC-delta and -epsilon regulate NF-kappaB activation induced by cholecystokinin and TNF-alpha in pancreatic acinar cells, Am. J. Physiol. Gastrointest. Liver Physiol. 287(3):G582-91. (Sep. 2004; Epub. Apr. 29, 2004).
Segal E, Shapira M, Regev A, Pe'er D, Botstein D, Koller D, Friedman N, Module networks: identifying regulatory modules and their condition-specific regulators from gene expression data, Nature Genetics 34(2):166-176 (2003).
Soltoff S P, Rottlerin is a mitochondrial uncoupler that decreases cellular ATP levels and indirectly blocks protein kinase C delta tyrosine phosphorylation, J. Biol. Chem. 276(41):37986-37992 (2001).
Srivastava S, Chan C, Hydrogen peroxide and hydroxyl radicals mediate palmitate-induced cytotoxicity to hepatoma cells: relation to MPT, Free Radical Res. (in review).
Steffen M, Petti A, Aach J, D'haeseleer P, Church G, Automated modelling of signal transduction networks, BMC Bioinformatics 3:34, pp. 1-11 (Nov. 1, 2002) (http://www.biomedcentral.com/content/pdf/1471-2105-3-34.pdf).
Tamatani M, Che Y H, Matsuzaki H, Ogawa S, Okado H, Miyake S-i, Mizuno T, Tohyama M, Tumor necrosis factor induces Bcl-2 and Bcl-x expression through NFkappa B activation in primary hippocampal neurons, J. Biol. Chem. 274(13):8531-8538 (1999).
Tanay A, Sharan R, Kupiec M, Shamir R, Revealing modularity and organization in the yeast molecular network by integrated analysis of highly heterogeneous genomewide data, Proc. Nat'l Acad. Sci. (USA) 101(9):2981-2986 (2004).
Weiner F R, Smith P J, Wertheimer S, Rubin C S, Regulation of gene expression by insulin and tumor necrosis factor alpha in 3T3-L1 cells: Modulation of the transcription of genes encoding acyl-CoA synthetase and stearoyl-CoA desaturase-1, J. Biol. Chem. 266(35):23525-23528 (Dec. 15, 1991).
Xu Z, Williams B R, The B56alpha regulatory subunit of protein phosphatase 2A is a target for regulation by double-stranded RNA-dependent protein kinase PKR, Molec. & Cell. Biol. 20(14):5285-5299 (July 2000).

What is claimed is:

1. A process for constructing a network of putative biological pathway(s) involved in production of a phenotype, the process comprising:
A. providing
(1) the identity of a phenotype of interest exhibited by a selected cellular entity; and
(2) at least four sets of data: (a) each set being obtained from a sample or group of samples of the cellular entity; (1) at least one of the data sets being a first data set obtained from a sample or sample group that exhibits a first level of the phenotype; and (2) at least one of the other data sets being a second data set obtained from a sample or sample group that exhibits a second level of the phenotype, different from the first level; and (3) the remainder of the at least four data sets, if any, being independently selected from among those obtained from a sample or sample group that either does not exhibit the phenotype or that exhibits a level of the phenotype the same as or different from either of those that provides the first and second data sets; and (b) each data set including (1) biomolecule expression data for a biomolecule class, at least two of the data sets' expression data each comprising a static biomolecule expression profile for the biomolecule class, and at least a first and a second of the static biomolecule expression profiles among the data sets respectively being static biomolecule profiles from the cellular entity exhibiting different levels of the phenotype; and (2) phenotype expression data that is a measure of, or proportional to, the phenotype expression level of the sample or sample group providing that data set;
B. performing a comparative analysis of the biomolecule expression profiles using Analysis of Variance (ANOVA) or an equivalent technique, or using a Partial Least Squares (PLS) Analysis, or both, to identify biomolecules whose expression level is significantly different in the cellular entity when exhibiting the phenotype to a greater degree, thereby identifying a set of altered-expression (AE) biomolecules;
C. performing an analysis of the AE biomolecules using a Genetic Algorithm-coupled Partial Least Squares technique (GA/PLS), or an equivalent technique, to assign relevance values to the AE biomolecules, proportional to their degree of correlation with the phenotype, and selecting the highest-relevance-valued AE biomolecules as the set of high-relevance AE (HAE) biomolecules, wherein the GA/PLS or equivalent technique is operated on at least the four data sets defined in step (A)(2), each of the data sets comprising biomolecular expression data for each of the AE biomolecules;
D. analyzing the GA/PLS-assigned relevance value of each of the HAE biomolecules, along with the biomolecule expression data for the HAE biomolecules and the phenotype expression data therefor, using Constrained Independent Component Analysis (CICA) to identify a subset of HAE biomolecules that are involved in a phenotype-expression-pathway(s), which biomolecules are thereby classified as a set of regulatory-function (RF) biomolecules;
E. analyzing the differences in expression for each of the RF biomolecules, as recorded in the biomolecule expression data, using Bayesian Network analysis to construct a network of RF biomolecules involved in producing the phenotype, each RF biomolecule being represented by a node and each node being connected to at least one other node by a connection representing the probability that those two biomolecules are functionally adjacent one another in a biological pathway in cyto, thereby obtaining said network of putative biological pathway(s).

2. The process according to claim 1, wherein the biomolecule class (A)(2)(b)(1) is any one of mRNAs, polypeptides, or metabolites, or a substantial subset thereof, and the network (E) respectively comprises putative gene, polypeptide, or metabolite pool pathway(s) as putative biological pathway(s).

3. The process according to claim 1, wherein said process further comprises providing annotations of, or other identity information for, AE or HAE biomolecules for their known or putative functions, and using the annotations or information to verify the relevance of AE biomolecules to the phenotype after step B and before step D, or to verify the relevance of HAE biomolecules to the phenotype after step C and before step D; and excluding from further analysis those AE or HAE biomolecules, respectively, whose functional information identified them as having little or no relevance to phenotype expression.

4. The process according to claim 1, the process further comprising the step, performed after step E, of identifying a node as representing a candidate target biomolecule by predicting the effect on the phenotype of perturbing the node in the network (E).

5. The process according to claim 1, the process further comprising the step, performed after step E, of storing the network (E) in a computer readable memory.

6. The process according to claim 1, the process further comprising the step, performed after step E, of:
Experimentally manipulating the cellular entity by employing at least one biomolecule-specific inhibition, inactivation, or enhancement technique to alter the amount or degree of activity of at least one biomolecule represented in the network (E), and based on the results of said experimental manipulation, revising the network, if needed, thereby obtaining a verified network, or validating a candidate target molecule as a target biomolecule, or both.

7. The process according to claim 6, further comprising utilizing the verified network to establish the biomolecular basis of the phenotype.

8. The process according to claim 7, wherein said biomolecular basis is the biomolecular basis of the toxicity of a given compound(s) or the biomolecular basis of the therapeutic effect of a given compound(s).

9. The process according to claim 6, further comprising utilizing the verified network to: (A) predict the phenotypic effect of contacting the cellular entity with a compound or condition that is related to the one utilized to produce the phenotype; (B) predict the phenotypic effect of contacting the cellular entity with, or withholding from thecellular entity, a compound utilized by a polypeptide in a polypeptide network, or an expression product of at least one gene of a gene network; (C) predict the phenotypic effect of contacting the cellular entity with a test compound related to a compound utilized by a polypeptide in a polypeptide network, or an expression product of at least one gene of a gene network; (D) predict the phenotypic effect of altering the activity of or encoded by a gene of a gene network; or (E) predict the interaction of network biomolecules with one another, based on perturbation of at least one network biomolecule.

10. The process according to claim 6, further comprising utilizing the verified network to identify a compound(s) or condition(s) at least suspected of being capable of enhancing, reducing, or eliminating the phenotype.

11. The process according to claim 6, further comprising reviewing the verified network to identify a gene, polypeptide, or metabolite target for use in developing a method for altering production of the phenotype.

12. The process according to claim 11, a gene target of a gene network being identified therein, wherein the gene target is: the whole gene, a regulatory region thereof, or a coding region thereof; an oligonucleotide comprising an at least eight-base-long portion of the base sequence of any of the same; a nucleic acid analog of any of the foregoing; an expression product of the gene, or a fragment of said expression product; or an analog of said expression product or fragment.

13. The process according to claim 11, wherein said use involves employing the gene, polypeptide, or metabolite target to screen a library of compound(s) in order to identify compound(s) that bind to said target.

14. The process according to claim 13, wherein the compound(s) to be screened are identified by a method involving utilizing the verified network to identify a compound(s) or condition(s) at least suspected of being capable of enhancing, reducing, or eliminating the phenotype.

15. The process according to claim 11, further comprising inhibiting, inactivating, or enhancing the identified gene target so as to alter the phenotype.

16. The process according to claim 11, wherein the gene target is a biocatalyst target or a biocatalyst-encoding gene target and the phenotype is the biosynthesis of a desired product, the biocatalyst participating in product biosynthesis.

17. A microprocessor programmed to perform a process according to claim 1, based on data provided to the microprocessor for use in step A2 of said process.

18. A data processing system comprising an input device, a processor, and an output device, the processor comprising a central processing unit and memory, wherein the processor is programmed to perform the process according to claim 1, and is programmed to receive step A2 data from the input device, and is programmed to transmit, to the output device, results of performing said process using said data.

19. The data processing system according to claim 18, wherein the output device is a display device and the processor is programmed to cause the display device to display said results.

20. A process for selecting a candidate target biomolecule for experimental verification as a target biomolecule, the process comprising:
A. providing
(1) the identity of a phenotype of interest exhibited by a selected cellular entity; and
(2) at least four sets of data: (a) each set being obtained from a sample or group of samples of the cellular entity; (1) at least one of the data sets being a first data set obtained from a sample or sample group that exhibits a first level of the phenotype; and (2) at least one of the other data sets being a second data set obtained from a sample or sample group that exhibits a second level of the phenotype, different from the first level; and (3) the remainder of the at least four data sets, if any, being independently selected from among those obtained from a sample or sample group that either does not exhibit the phenotype or that exhibits a level of the phenotype the same as or different from either of those that provides the first and second data sets; and (b) each data set including (1) biomolecule expression data for a biomolecule class, at least two of the data sets' expression data each comprising a static biomolecule expression profile for the biomolecule class, and at least a first and a second of the static biomolecule expression profiles among the data sets respectively being static biomolecule profiles from the cellular entity exhibiting different levels of the phenotype; and (2) phenotype expression data that is a measure of, or proportional to, the phenotype expression level of the sample or sample group providing that data set;
B. performing a comparative analysis of the biomolecule expression profiles using Analysis of Variance (ANOVA) or an equivalent technique, or using a Partial Least Squares (PLS) Analysis, or both, to identify biomolecules whose expression level is significantly different in the cellular entity when exhibiting the phenotype to a greater degree, thereby identifying a set of altered-expression (AE) biomolecules;
C. performing an analysis of the AE biomolecules using a Genetic Algorithm-coupled Partial Least Squares technique (GA/PLS), or an equivalent technique, to assign relevance values to the AE biomolecules, proportional to their degree of correlation with the phenotype, and selecting the highest-relevance-valued AE biomolecules as the set of high-relevance AE (HAE) biomolecules, wherein the GA/PLS or equivalent technique is operated on at least the four data sets defined in step (A)(2), each of the data sets comprising biomolecular expression data for each of the AE biomolecules;
D. analyzing the GA/PLS-assigned relevance value of each of the HAE biomolecules, along with the biomolecule-expression data for the HAE biomolecules and the phenotype expression data therefor, using Constrained Independent Component Analysis (CICA) to identify a subset of HAE biomolecules that are involved in a phenotype-expression-pathway(s), which biomolecules are thereby classified as a set of regulatory-function (RF) biomolecules;
E. analyzing the differences in expression for each of the RF biomolecules, as recorded in the biomolecule expression data, using Bayesian Network analysis to construct a network of RF biomolecules involved in producing the phenotype, each RF biomolecule being represented by a node and each node being connected to at least one other node by a connection (edge) representing the probability that those two biomolecules are functionally adjacent one another in a biological pathway in cyto, thereby obtaining said network of putative biological pathway(s); and
F. identifying a node as representing a candidate target biomolecule by predicting the effect on the phenotype of perturbing the node in the network (E).

21. The process according to claim 20, wherein the verified target molecule is for use in drug development, molecular medicine, or phenotype modification.

22. A Bayesian network comprising a plural number of nodes representing biomolecules, a plurality of edges connecting said nodes, the edges representing the probability that the biomolecules are functionally adjacent one another in a biological pathway in cyto, wherein said nodes and edges are operably connected by evaluating the relationships by
A. providing
(1) the identity of a phenotype of interest exhibited by a selected cellular entity; and
(2) at least four sets of data: (a) each set being obtained from a sample or group of samples of the cellular entity; (1) at least one of the data sets being a first data set obtained from a sample or sample group that exhibits a first level of the phenotype; and (2) at least one of the other data sets being a second data set obtained from a sample or sample group that exhibits a second level of the phenotype, different from the first level; and (3) the remainder of the at least four data sets, if any, being independently selected from among those obtained from a sample or sample group that either does not exhibit the phenotype or that exhibits a level of the phenotype the same as or different from either of those that provides the first and second data sets; and (b) each data set including (1) biomolecule expression data for a biomolecule class, at least two of the data sets' expression data each comprising a static biomolecule expression profile for the biomolecule class, and at least a first and a second of the static biomolecule expression profiles among the data sets respectively being static biomolecule profiles from the cellular entity exhibiting different levels of the phenotype; and (2) phenotype expression data that is a measure of, or proportional to, the phenotype expression level of the sample or sample group providing that data set;
B. performing a comparative analysis of the biomolecule expression profiles using Analysis of Variance (ANOVA) or an equivalent technique, or using a Partial Least Squares (PLS) Analysis, or both, to identify biomolecules whose expression level is significantly different in the cellular entity when exhibiting the phenotype to a greater degree, thereby identifying a set of altered-expression (AE) biomolecules;
C. performing an analysis of the AE biomolecules using a Genetic Algorithm-coupled Partial Least Squares technique (GA/PLS), or an equivalent technique, to assign relevance values to the AE biomolecules, proportional to their degree of correlation with the phenotype, and selecting the highest-relevance-valued AE biomolecules as the set of high-relevance AE (HAE) biomolecules, wherein the GA/PLS or equivalent technique is operated on at least the four data sets defined in step (A)(2), each of the data sets comprising biomolecular expression data for each of the AE biomolecules;
D. analyzing the GA/PLS-assigned relevance value of each of the HAE biomolecules, along with the biomolecule expression data for the HAE biomolecules and the phenotype expression data therefor, using Constrained Independent Component Analysis (CICA) to identify a subset of HAE biomolecules that are involved in a phenotype-expression-pathway(s), which biomolecules are thereby classified as a set of regulatory-function (RF) biomolecules;
E. analyzing the differences in expression for each of the RF biomolecules, as recorded in the biomolecule expression data, using Bayesian Network analysis to construct a network of RF biomolecules involved in producing the phenotype, each RF biomolecule being represented by a node and each node being connected to at least one other node by a connection (edge) representing the probability that those two biomolecules are functionally adjacent one another in a biological pathway in cyto, thereby obtaining said network of putative biological pathway(s)

23. The Bayesian network according to claim 22, wherein said network is stored in a computer readable memory.

24. A computer software product, comprising computer-readable media with instructions to enable a computer to implement a process for constructing a Bayesian network of putative biological pathway(s), the instructions comprising:
A. instructions for receiving as input at least four sets of data:
(a) each set being obtained from a sample or group of samples of the cellular entity; (1) at least one of the data sets being a first data set obtained from a sample or sample group that exhibits a first level of the phenotype; and (2) at least one of the other data sets being a second data set obtained from a sample or sample group that exhibits a second level of the phenotype, different from the first level; and (3) the remainder of the at least four data sets, if any, being independently selected from among those obtained from a sample or sample group that either does not exhibit the phenotype or that exhibits a level of the phenotype the same as or different from either of those that provides the first and second data sets; and (b) each data set including (1) biomolecule expression data for a biomolecule class, at least two of the data sets' expression data each comprising a static biomolecule expression profile for the biomolecule class, and at least a first and a second of the static biomolecule expression profiles among the data sets respectively being static biomolecule profiles from the cellular entity exhibiting different levels of the phenotype; and (2) phenotype expression data that is a measure of, or proportional to, the phenotype expression level of the sample or sample group providing that data set;
B. instructions for performing a comparative analysis of the biomolecule expression profiles using Analysis of Variance (ANOVA) or an equivalent technique, or using a Partial Least Squares (PLS) Analysis, or both, to identify biomolecules whose expression level is significantly different in the cellular entity when exhibiting the phenotype to a greater degree, thereby identifying a set of altered-expression (AE) biomolecules;
C. instructions for performing an analysis of the AE biomolecules using a Genetic Algorithm-coupled Partial Least Squares technique (GA/PLS), or an equivalent technique, to assign relevance values to the AE biomolecules, proportional to their degree of correlation with the phenotype, and selecting the highest-relevance-valued AE biomolecules as the set of high-relevance AE (HAE) biomolecules, wherein the GA/PLS or equivalent technique is operated on at least the four data sets defined in step (A)(2), each of the data sets comprising biomolecular expression data for each of the AE biomolecules;
D. instructions for analyzing the GA/PLS-assigned relevance value of each of the HAE biomolecules, along with the biomolecule expression data for the HAE biomolecules and the phenotype expression data therefor, using Constrained Independent Component Analysis (CICA) to identify a subset of HAE biomolecules that are involved in a phenotype-expression-pathway(s), which biomolecules are thereby classified as a set of regulatory-function (RF) biomolecules; and
E. instructions for analyzing the differences in expression for each of the RF biomolecules, as recorded in the biomolecule expression data, using Bayesian Network analysis to construct a network of RF biomolecules involved in producing the phenotype, each RF biomolecule being represented by a node and each node being connected to at least one other node by a connection representing the probability that those two biomolecules are functionally adjacent one another in a biological pathway in cyto, thereby obtaining said network of putative biological pathway(s).
